(19) United States
(12) Patent Application Publication
(10) Pub. No.: US 2013/0170949 A1
(43) Pub. Date: Jul. 4, 2013

(54) WIND TURBINES AND METHODS FOR CAPTURING WIND ENERGY

(71) Applicant: Nebula Energy Inc., East Hartford, CT (US)

(72) Inventor: Davian A. Samuels, East Hartford, CT (US)

(73) Assignee: NEBULA ENERGY INC., East Hartford, CT (US)

(21) Appl. No.: 13/731,938

(22) Filed: Dec. 31, 2012

Related U.S. Application Data
(60) Provisional application No. 61/581,742, filed on Dec. 30, 2011.

(51) Int. Cl. F03D 3/04

(52) U.S. Cl. CPC F03D 3/0409
USPC 415/1; 415/208.1; 415/121.3

(57) ABSTRACT

Wind turbines and energy capturing assemblies for capturing fluid energy are provided. The wind turbines includes a plurality of helical air foil blades mounted for rotation about an axis, and a cylindrical airfoil mounted along the axis and shaped to direct a flow of fluid, such as, air or water, toward the plurality of helical airfoil blades. Incorporating photovoltaic devices within the turbines can enhance the energy capturing capacity of some turbines. The energy capturing assemblies include a plurality of airfoil blades mounted for rotation about an axis, a structure having an outer surface shaped to direct a flow of fluid toward the plurality of airfoil blades; and an electrical generator operatively connected to the plurality of airfoil blades. The structure may be a building, a residence, a tower, a tank, or a vessel. Methods and devices for capturing fluid energy are also included.

### CROSS-REFERENCE TO RELATED APPLICATIONS

This application claims priority from pending U.S. Provisional Patent Application 61/581,742, filed on Dec. 30, 2011, the disclosure of which is included by reference herein in its entirety.

This application is also related to copending U.S. application Ser. No. 13/676,068 filed on Nov. 13, 2012, entitled “SOLAR ENERGY COLLECTORS AND METHODS FOR CAPTURING SOLAR ENERGY,” the disclosure of which is incorporated by reference herein in its entirety.

### BACKGROUND OF THE INVENTION

1. Technical Field

The present invention generally relates to the capturing of wind energy and the conversion of that wind energy to electrical energy. More particularly, the present invention relates to systems, assemblies, devices, and methods for enhancing the collection of wind energy by directing the wind flow to wind-energy-capturing airfoils.

2. Description of Related Art

The acute recognition of the decline in the availability of fossil fuels and the limitation of fossil fuels for providing global energy needs continues to direct attention to the development of alternate energy sources. One source of renewable energy receiving increased attention is the plentiful and renewable supply of wind energy, that is, the conversion of wind energy to electrical energy from the rotation of wind turbines powered by wind.

As is known in the art, there are two classes of wind turbines: (1) the horizontal-axis wind turbine (HAWT) having propeller-type blades; and (2) the vertical-axis wind turbine (VAWT) having vertically-oriented blades. Though effective in many locations, due to their large blade diameters, HAWTs are typically not as appropriate in congested or crowded environments, such as, near and around buildings in a suburban or an urban environment. The typically smaller, more compact design of the VAWT is more conducive to mounting and operation on homes, factories, and other buildings.

VAWT technology is characterized by two approaches: (1) the drag-type or Savonius-type wind turbine, as exemplified, by U.S. Pat. No. 1,697,574 of Savonius, and (2) the lift-type or Darrieus-type wind turbine, as exemplified, by U.S. Pat. No. 1,835,018 of Darrieus, which are included by reference herein. Each of these VAWTs has different performance characteristics. For example, the Savonius wind turbine, characterized by bucket-type rotors, is effective in “self-starting,” that is, accelerating the turbine from zero speed, for example, without the need for ancillary starting equipment and the power the starting equipment requires. In addition, Savonius wind turbines are by their nature limited in rotational speed to the speed of the wind impacting the turbine; that is, the Savonius turbine can only turn as fast as the wind blows. As is known in the art, the ratio of the speed of the tip of the turbine blade to the speed of the impelling wind is referred to as the “tip speed ratio” (TSR). For the Savonius-type turbine, the TSR is limited to the maximum TSR of 1.0 or slightly higher, and typically the TSR of Savonius turbines is less than 1.0. Since the speed of a Savonius turbine is limited, the energy that can be extracted from wind by a Savonius turbine is also limited.

Darrieus-type turbines or lift-type turbines benefit from the effect of aerodynamic lift whereby Darrieus turbines can typically rotate faster than the speed of the impelling wind. For example, Darrieus turbines can have TSRs of greater than unity and can reach TSRs of 4.0 or more. Accordingly, typically, the larger kinetic energy of the Darrieus turbine can harvest much more energy from wind than a Savonius turbine.

Aspects of the present invention provide improved Darrieus-type wind turbines or lift-type wind turbines having enhanced wind-energy-capturing capability.

### SUMMARY OF THE INVENTION

Aspects of the present invention provides wind turbines and related assemblies having fluid guiding structures which direct fluid flow toward rotatably mounted airfoils to enhance the energy capturing capacity of the wind turbines.

One embodiment of the invention is a wind turbine including or comprising a plurality of helical airfoil blades mounted for rotation about an axis; and a cylindrical airfoil mounted along the axis and shaped to direct a flow of air toward the plurality of helical airfoil blades. In one aspect, either the plurality of helical airfoil blades or the cylindrical airfoil or both are adapted to drive an electrical generator. In one aspect, the plurality of helical airfoil blades comprises three sets of spaced helical blades. In another aspect, the cylindrical airfoil may include a plurality of photovoltaic devices and/or a plurality of reflective surfaces adapted to reflect sunlight onto the plurality of photovoltaic devices. In a further aspect, the wind turbine may further include a means for directing wind to provide the flow of air, for example, a surface or baffle positioned to capture and direct the wind toward the cylindrical airfoil.

Another embodiment of the invention is a method for capturing wind energy including or comprising mounting a plurality of helical airfoil blades for rotation about an axis; positioning a cylindrical airfoil along the axis; and allowing a surface of the cylindrical airfoil to direct a flow of air toward the plurality of helical airfoil blades to at least partially assist in rotating the plurality of helical airfoil blades. In one aspect, the method further comprises driving an electric generator by a means of the plurality of helical airfoil blades or the cylindrical airfoil or both. In one aspect, positioning the cylindrical airfoil along the axis comprises rotatably mounting the cylindrical airfoil along the axis. The method may further include capturing solar energy with a plurality of photovoltaic devices positioned on the cylindrical airfoil, for example, by reflecting sunlight onto the plurality of photovoltaic devices. In one aspect, the method may include positioning a surface adapted to capture and direct the wind toward the cylindrical airfoil.

A further embodiment of the invention is an energy capturing assembly including or comprising a plurality of airfoil blades mounted for rotation about an axis; a structure having an outer surface shaped to direct a flow of fluid toward the plurality of airfoil blades; and an electrical generator operatively connected to the plurality of airfoil blades. The structure may be a building, a residence, a tower, a tank, and a vessel, among other structures. The structure may have a base and an apex opposite the base, and each of the plurality of helical airfoil blades may comprise an end mounted to the apex of the structure. In one aspect, the outer surface of the structure may be radially symmetric about the axis. In another aspect, the plurality of airfoil blades comprises a plurality of helical airfoil blades. The assembly may be used to capture energy from wind or wave action. In another aspect, the outer surface may be a conical outer surface, a spherical outer surface, an ellipsoidal outer surface, a parabolic outer surface, or a hyperbolic outer surface.

A still further aspect of the invention is a method for capturing fluid energy capturing, the method including or comprising mounting a plurality of airfoil blades for rotation about an axis, the airfoil blades operatively connected to an electrical generator; positioning a structure having an outer surface shaped to direct a flow of fluid toward the plurality of airfoil blades; and exposing the plurality of airfoil blades to a fluid flow wherein the plurality of airfoil blades are rotated, and wherein electrical energy is produced by the electrical generator. In one aspect, the outer surface of the structure may be radially symmetric about the axis. In another aspect, the plurality of airfoil blades may be a plurality of helical airfoil blades. The fluid may air or water.

A further embodiment of the invention is a wind turbine including or comprising a plurality of helical airfoil blades mounted for rotation about an axis; and a circular cylinder rotationally mounted along the axis and having an outer surface comprising a plurality of helical grooves. In one aspect, the helical direction of the plurality of airfoil blades and the helical direction of the plurality of the helical grooves are substantially the same. In another aspect, the turbine may further include an electrical generator, for example, wherein a rotor of the electrical generator is coupled to the circular cylinder. In one aspect, the plurality of helical airfoil blades may freely rotate. In another aspect, the free rotation of the plurality of helical airfoil blades may promote the rotation of the circular cylinder. In a further aspect, the plurality of helical grooves of the circular cylinder may accelerate a flow of fluid upon the plurality of the helical airfoil blades. The fluid may be air or water.

According to another embodiment a method is provided for capturing fluid energy, such as wind or wave action. The method includes or comprises mounting a plurality of helical airfoil blades for rotation about an axis; providing a circular cylinder rotationally mounted along the axis and having an outer surface comprising a plurality of helical grooves, and wherein the circular cylinder is coupled to an electrical generator; exposing the circular cylinder to a flow wherein the circular cylinder and the electrical generator are rotated to produce electrical energy. In one aspect, the method may further include promoting rotation of the circular cylinder by a rotation of the plurality of helical airfoil blades. In another aspect, the method may further include promoting a flow of fluid upon the plurality of the helical airfoil blades with the helical grooves of the circular cylinder. In one aspect, mounting the circular cylinder may be practiced by rotatably mounting the circular cylinder within an inner radius of the helical airfoil blades.

These and other aspects, features, and advantages of this invention will become apparent from the following detailed description of the various aspects of the invention taken in conjunction with the accompanying drawings

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention will be readily understood from the following detailed description of aspects of the invention taken in conjunction with the accompanying drawings in which:

FIG. 1 is a perspective view of a wind turbine or wind turbine assembly according to one aspect of the invention.

FIG. 2 is a side elevation view of the wind turbine shown in FIG. 1.

FIG. 3 is a top plan view of the wind turbine shown in FIG. 1.

FIG. 4 is a cross section view of the wind turbine shown in FIG. 1 as viewed along section lines 4-4 shown in FIG. 2.

FIG. 5 is a cross section view similar to that shown in FIG. 4 but having an alternate circular cylindrical airfoil according to one aspect of the invention.

FIG. 6 is a cross section view similar to that shown in FIG. 4 but having another alternate teardrop-shaped cylindrical airfoil according to one aspect of the invention.

FIG. 7 is an exploded perspective view of the wind turbine shown in FIG. 1.

FIG. 8 is a perspective view of wind turbine or wind turbine assembly having photovoltaic devices according to one aspect of the invention.

FIG. 9 is a front elevation view of wind turbine or wind turbine assembly shown in FIG. 8.

FIG. 10 is a front elevation view of one means for mounting the wind turbine shown in FIG. 1, according to one aspect of the invention.

FIG. 11 is a front elevation view of another means for mounting the wind turbine shown in FIG. 1, according to one aspect of the invention.

FIG. 12 is a perspective view of an arrangement for mounting another wind turbine or wind turbine assembly according to another aspect of the invention.

FIG. 13 is a perspective view of the wind turbine or wind turbine assembly shown in FIG. 12, including showing a roof in phantom for reference.

FIG. 14 is a front elevation view of the wind turbine assembly shown in FIG. 13.

FIG. 15 is a left side elevation view of a wind turbine assembly shown in FIG. 13, the right side elevation view being a mirror image thereof.

FIG. 16 is an exploded perspective view of the wind turbine assembly shown in FIG. 12.

FIG. 17 is a perspective view of a tower assembly having a plurality of wind turbines according to one aspect of the invention.

FIG. 18 is a perspective view of one energy capturing assembly according to another embodiment of the invention.

FIG. 19 is a side elevation view of the energy capturing assembly shown in FIG. 18.

FIG. 20 is a top plan view of the energy capturing assembly shown in FIG. 18.

FIG. 21 is a perspective view of another energy capturing assembly according to another embodiment of the invention.

FIG. 22 is a side elevation view of the energy capturing assembly shown in FIG. 21.

FIG. 23 is a top plan view of the energy capturing assembly shown in FIG. 21.

FIG. 24 is a perspective view of another energy capturing assembly according to another embodiment of the invention.

FIG. 25 is a side elevation view of the energy capturing assembly shown in FIG. 24.

FIG. 26 is a top plan view of the energy capturing assembly shown in FIG. 24.

FIG. 27 is a perspective view of another energy capturing assembly according to another embodiment of the invention.

FIG. 28 is a side elevation view of the energy capturing assembly shown in FIG. 27.

FIG. 29 is a perspective view of a wind turbine or wind turbine assembly according to further embodiment of the invention.

FIG. 30 is a side elevation view of the wind turbine or wind turbine assembly shown in FIG. 29.

FIG. 31 is a perspective view, partially in cross section, of the wind turbine or wind turbine assembly shown in FIG. 29.

FIG. 32 is a cross section view of the wind turbine or wind turbine assembly shown in FIG. 29 as viewed along section lines 32-32 shown in FIG. 30.

FIG. 33 is an exploded perspective view of the wind turbine or wind turbine assembly shown in FIG. 29.

### DETAILED DESCRIPTION OF THE INVENTION

Aspects of the present invention provide a more efficient Darrieus-type wind turbine system by introducing wind-directing structures adapted to concentrate and direct wind energy toward helical turbine airfoil blades. Aspects of the invention can comprise individual stand-alone units or components of larger, multi-unit systems, for example, that can be mounted on any convenient structure, for example, a tower, pole, or a rooftop.

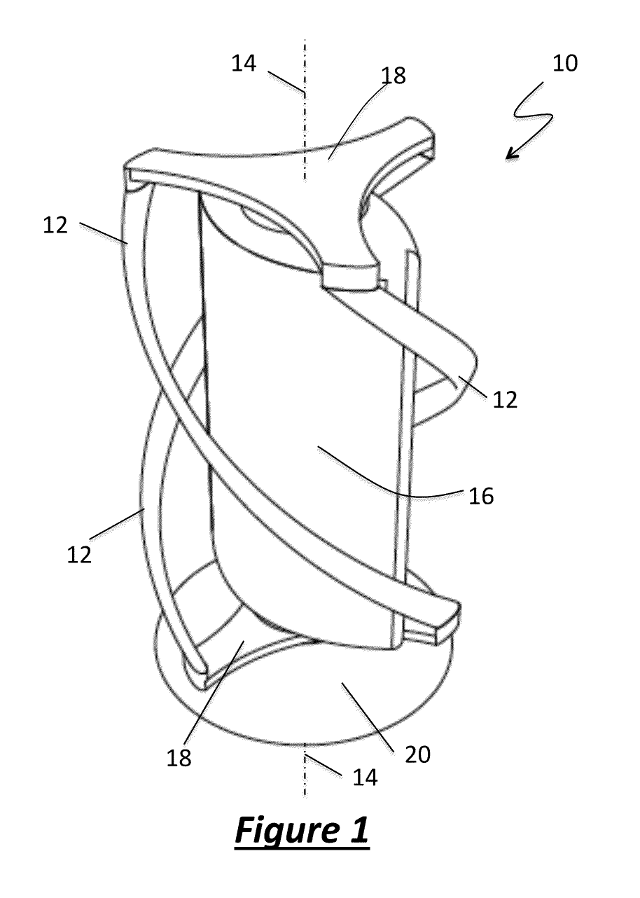

FIG. 1 is a perspective view of wind turbine or wind turbine assembly 10 according to one aspect of the invention. As shown in FIG. 1, wind turbine 10 typically includes at least one, but typically, a plurality of airfoil blades 12 mounted for rotation about an axis 14, and a cylindrical airfoil 16 mounted along the axis 14 and shaped to promote, concentrate, or direct a flow of air toward the plurality of airfoil blades 12. According to aspects of the present invention, this promotion, concentration, or direction of a flow of air enhances the rotation and loading of airfoil blades 12 and accordingly enhances the capture of wind energy by airfoil blades 12. In the aspect shown in FIG. 1, wind turbine 10 includes three (3) elongated airfoil blades 12, though one or more blades 12 may be used, for example, three (3) or more or four (4) or more blades 12 may be used, for instance, blades 12 may be evenly spaced about wind turbine 10.

As shown in FIG. 1, airfoil blades 12 may be mounted for rotation about axis 14 by means of blade connectors 18 to which airfoil blades 12 are mounted and which may be adapted to be rotatable about axis 14. According to aspects of the invention, the plurality of airfoil blades 12, the cylindrical airfoil 16, or both are operatively connected to one or more electrical generators (not shown) to generate electric energy or power from the wind energy captured by the rotation of airfoil blades 12 and/or cylindrical airfoil 16. The one or more electrical generators may be mounted, for example, in housing or base 20. Though not shown in the figures for the sake of simplicity, it is to be understood that aspects of the invention may include appropriate electrical wiring and/or cabling to, among other things, transmit the electrical energy generated to an adjacent or remote load, and/or to monitor and/or control the operation of the wind turbine 10 and components thereof.

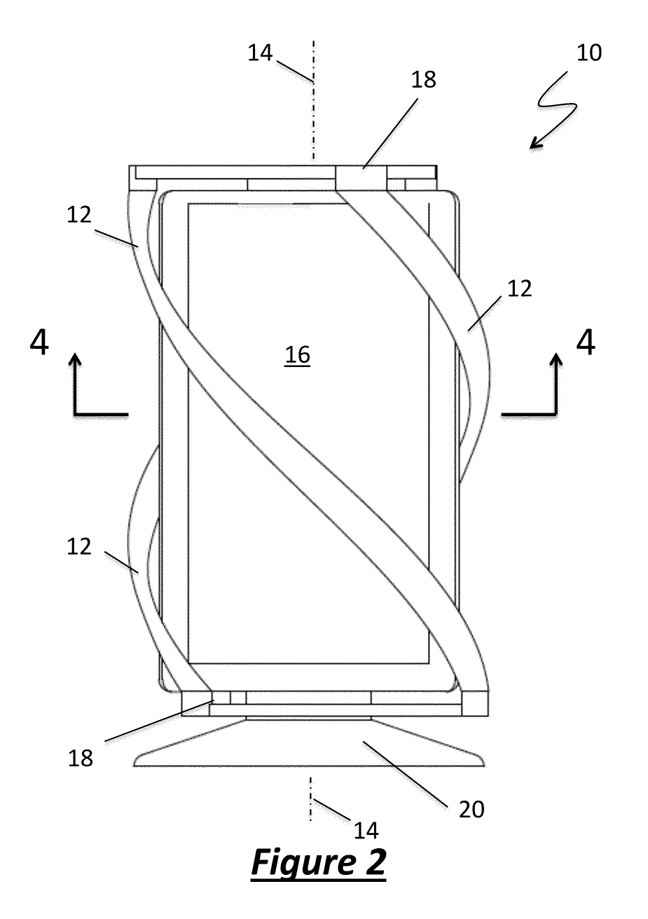

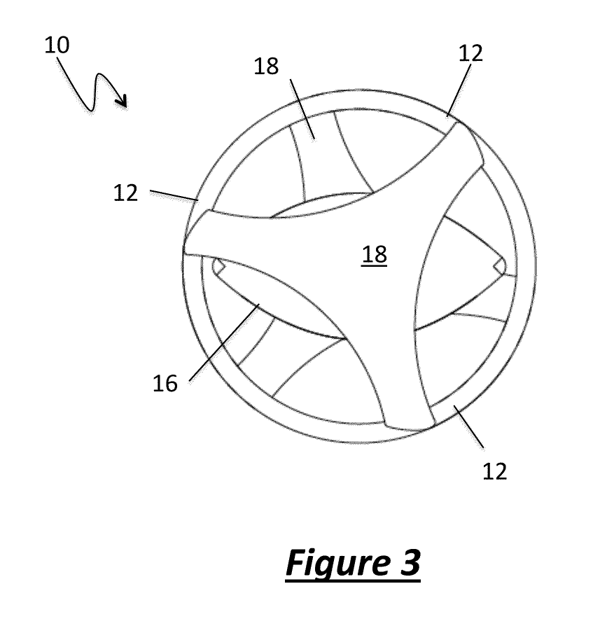

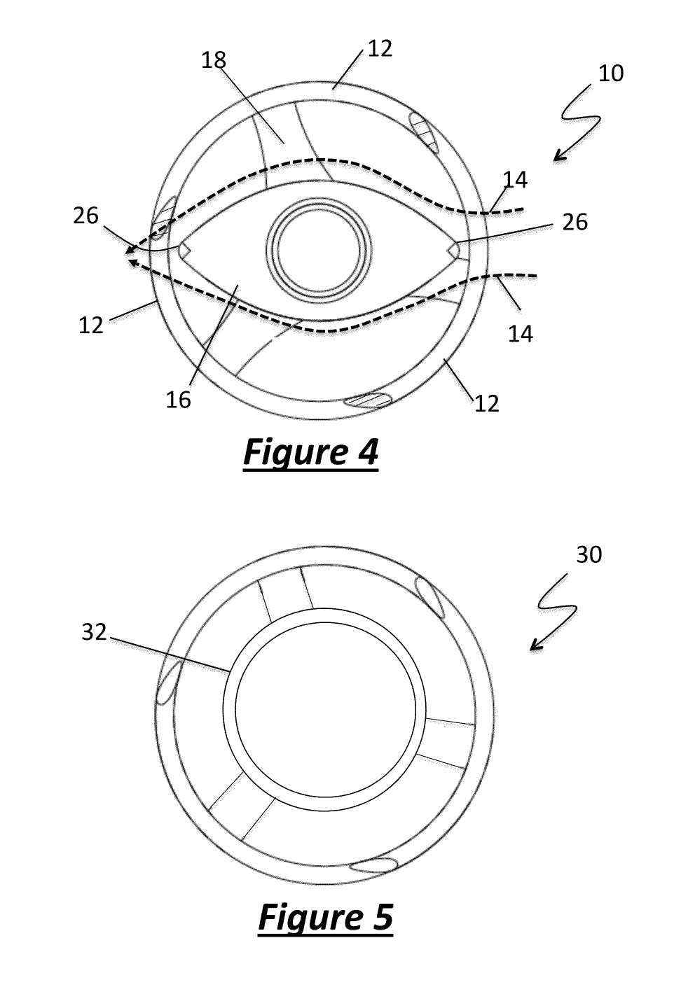

FIG. 2 is a side elevation view of the wind turbine 10 shown in FIG. 1. FIG. 3 is a top plan view of the wind turbine 10 shown in FIG. 1. FIG. 4 is a cross sectional view of the wind turbine shown 10 in FIG. 1 as viewed along section lines 4-4 shown in FIG. 2. Though the axis 14 shown in FIGS. 1-4 is directed substantially vertically, according to aspects of the invention, the axis 14 may be directed in any orientation, for example, horizontally or even at an angle to the horizontal or vertical direction, for instance, at a 45 degree angle, among other angles, from the horizontal or vertical direction.

As shown in FIG. 4, in one aspect of the invention, cylindrical airfoil 16 may be streamlined, contoured, or otherwise shaped to promote the capture and directing of wind, as shown by dashed arrows 14, and direct the wind 14 toward airfoil blades 12. In one aspect, the shape of cylindrical airfoil 16 is adapted to promote or direct wind 14 toward airfoil blades 12 to enhance the wind load on airfoils 12 (and thus the torque transmitted by airfoils 12) and increase the wind energy captured and converted to electrical energy. In the aspect of the invention shown in FIG. 4, cylindrical airfoil 16 comprises an elliptical or oval shape in cross section, for example, with substantially rounded or radiused ends 26 (that is, a shape that sometimes is referred to as a “lens” shape, a “marquise” shape, a “navette” shape, or a “boat” shape). In one aspect, ends 26 may be shaped to substantially come to a point or a radiused point. As shown in FIG. 4, the marquise shape of the surface of cylindrical airfoil 16 deflects wind 14 or promotes the flow of wind 14, for example, in a direction toward airfoil blades 12, for instance, in a direction substantially parallel to the axis of the cross section of airfoil blades 12.

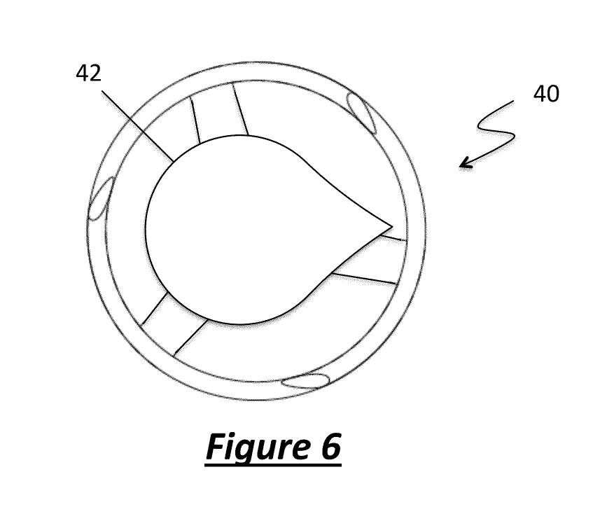

FIG. 5 is a cross section view similar to FIG. 4 of a wind turbine 30, similar to wind turbine 10 shown in FIG. 1, having an alternate circular cylindrical airfoil 32 according to one aspect of the invention. FIG. 6 is a cross section view similar to FIG. 4 of a wind turbine 40, similar to wind turbines 10 and 30 shown in FIGS. 1 and 5, respectively, having an alternate teardrop-shaped cylindrical airfoil 42 according to one aspect of the invention.

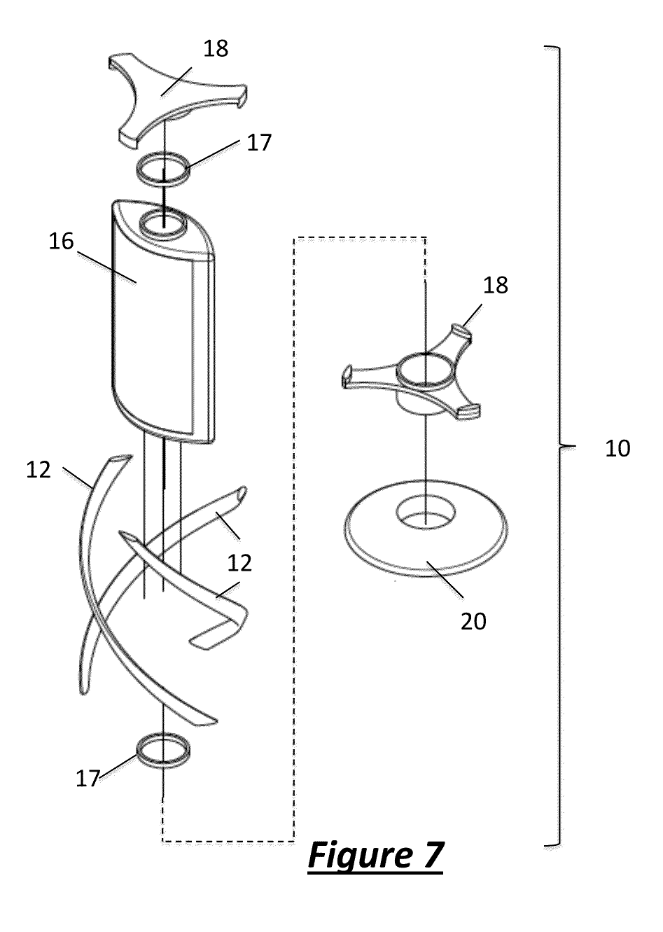

FIG. 7 is an exploded perspective view of the wind turbine 10 shown in FIG. 1. As shown in FIG. 7, in addition to having a plurality of airfoil blades 12, a cylindrical airfoil 16, blade connectors 18, and housing or base 20, wind turbine 18 may also typically include a friction reducing devices 17, for example, roller bearings, journal bearings, friction reducing materials (such as, DuPont's Teflon® polytetrafluoroethylene (PTFE) or Saint-Gobain's Rulon® PTFE or their equivalents), and/or a lubricated surface.

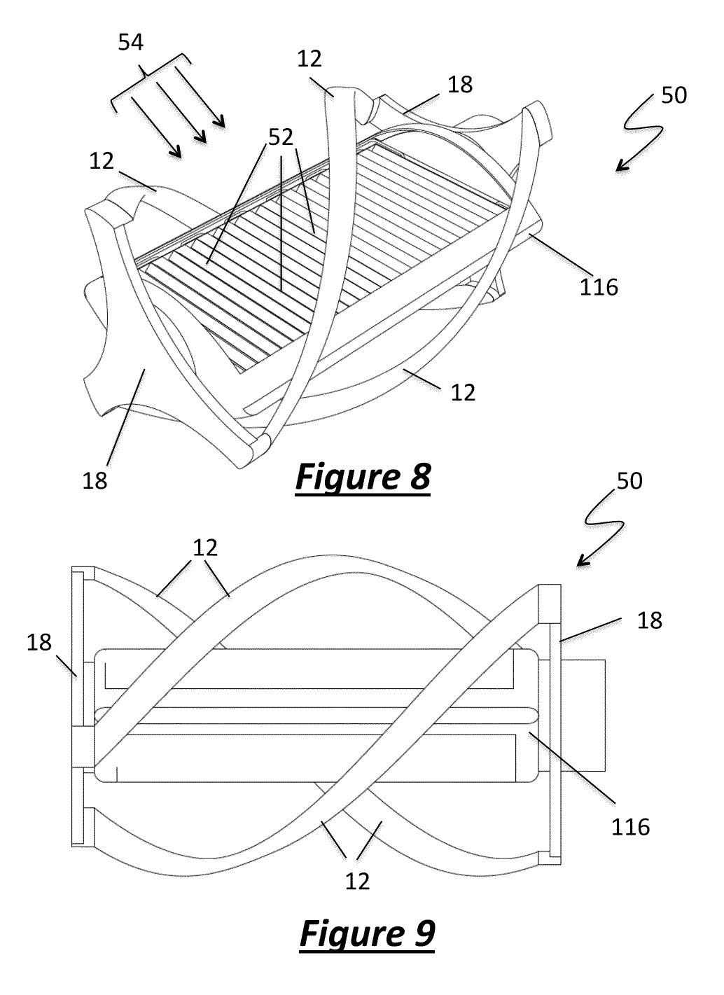

FIG. 8 is a perspective view of a wind turbine or wind turbine assembly 50 having photovoltaic devices 52 according to one aspect of the invention. FIG. 9 is a front elevation view of the wind turbine or wind turbine assembly 50 shown in FIG. 8. As shown in FIGS. 8 and 9, in addition to having a plurality of airfoil blades 12, a cylindrical airfoil 116 (for example, similar to cylindrical airfoil 16), and blade connectors 18 (as shown and described with respect to FIGS. 1 through 7), wind turbine 50 may also typically include one or more photovoltaic devices 52, for example, typically, a plurality of photovoltaic devices 52. As known in the art, a photovoltaic device (or a “PV device”) may be any conventional device adapted to convert incident solar radiation, as indicated schematically by arrows 54 in FIG. 8, to electrical energy. PV devices 52 may, for example, be generally referred to as “solar cells,” and the like, as known in the alt.

According to one aspect of the invention, PV devices 52 may positioned on airfoil 116, for example, on an outer surface of airfoil 116 or within cylindrical airfoil 116, for example, in a cavity or recess of airfoil 116 adapted to be exposed to solar radiation 54. In one aspect, cylindrical airfoil 116 may comprise the housing disclosed in copending U.S. application Ser. No. 13/676,068, which is included by reference herein in its entirety. For example, cylindrical airfoil 116 shown in FIGS. 8 and 9 may comprise the PV module disclosed in U.S. application Ser. No. '068 (by reference number 16), for example, including PV devices 42 described in the '068 application. In one aspect, cylindrical airfoil 116 may include one or more solar concentrator and heat exchanger assemblies disclosed in application '068 (by reference number 44) having the arrangement of PV devices (40) and/or reflective surfaces (42) disclosed therein adapted to reflect sunlight onto the plurality of PV devices (40).

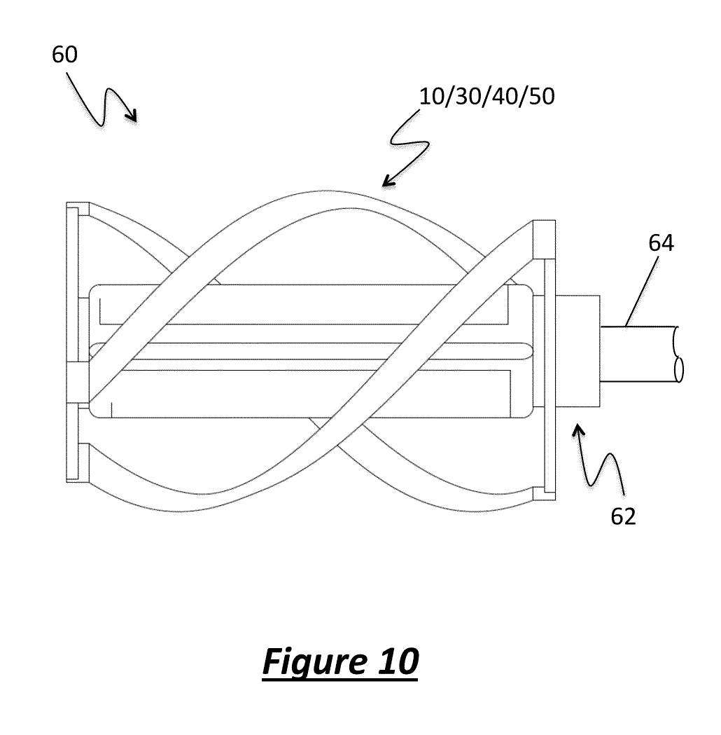

FIG. 10 is a partial elevation view of wind turbine or wind turbine assembly 60 shown mounted in one orientation by one mounting arrangement 62 according to one aspect of the invention. As shown, according to this aspect the turbine assembly 60, for example, any one of turbine assemblies 10, 30, 40, or 50 disclosed herein, may be mounted in a substantially horizontal orientation by mounting arrangement 62 comprising an arm, support, or similar structure 64. For example, arm or support 64 may be mounted to a surface or a structure (not shown), for example, a vertical support, stanchion, building, for instance, to a wall of a building, or any surface or structure adapted to expose turbine assembly 60 to a flow of fluid, such as, wind or water. According to this aspect of the invention, the electric generator (not shown) operatively connected to the helical airfoil blades and/or cylindrical airfoil of turbine assembly 60 may be housed in a hollow arm, support, or similar structure 64, or accessed via arm or support 64, for example, arm or support 64 may be rotatable and driven by turbine assembly 60. Aspects of the invention may include a plurality of wind turbine assemblies 60 mounted to a common structure (not shown) by a plurality of mounting arrangements 62.

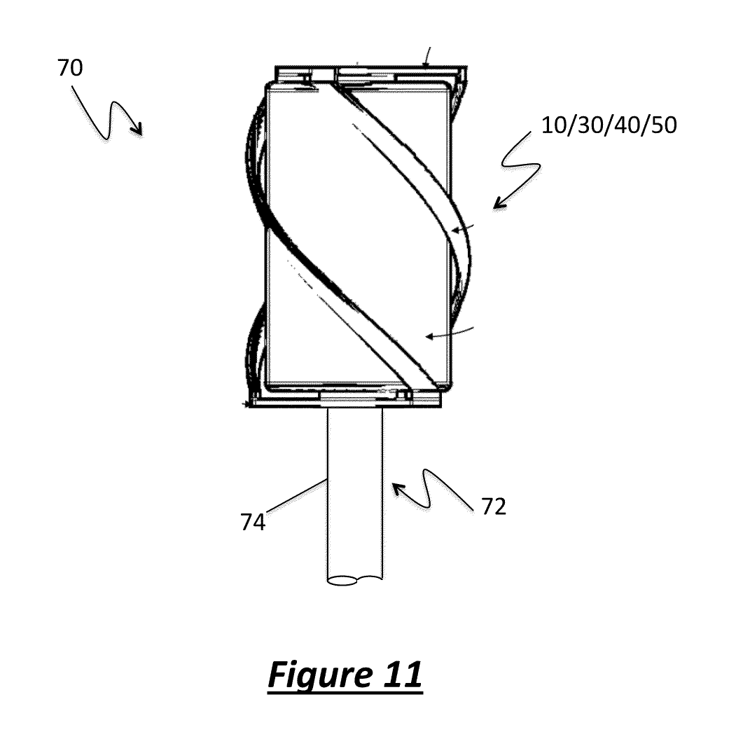

FIG. 11 is a partial elevation view of wind turbine or wind turbine assembly 70 shown mounted in another orientation by another mounting arrangement 72 according to one aspect of the invention. As shown, according to this aspect, the turbine assembly 70, for example, any one of turbine assemblies 10, 30, 40, or 50 disclosed herein, may be mounted in a substantially vertical orientation by mounting arrangement 72 comprising a pole, support, or similar structure 74. For example, pole or support 74 may be mounted to a structure (not shown), for example, to ground, to a horizontal surface or support, to a building, for instance, to a roof of a building, or to any surface or structure adapted to expose turbine assembly 70 to a flow of fluid, such as, wind or water. According to this aspect of the invention, the electric generator (not shown) operatively connected to the helical airfoil blades and/or cylindrical airfoil of turbine assembly 70 may be housed in a hollow pole, support, or similar structure 74, or accessed via pole or support 74, for example, pole or support 74 may be rotatable and driven by turbine assembly 70. Aspects of the invention may include a plurality of wind turbine assemblies 70 mounted to a common structure (not shown) by a plurality of mounting arrangements 72.

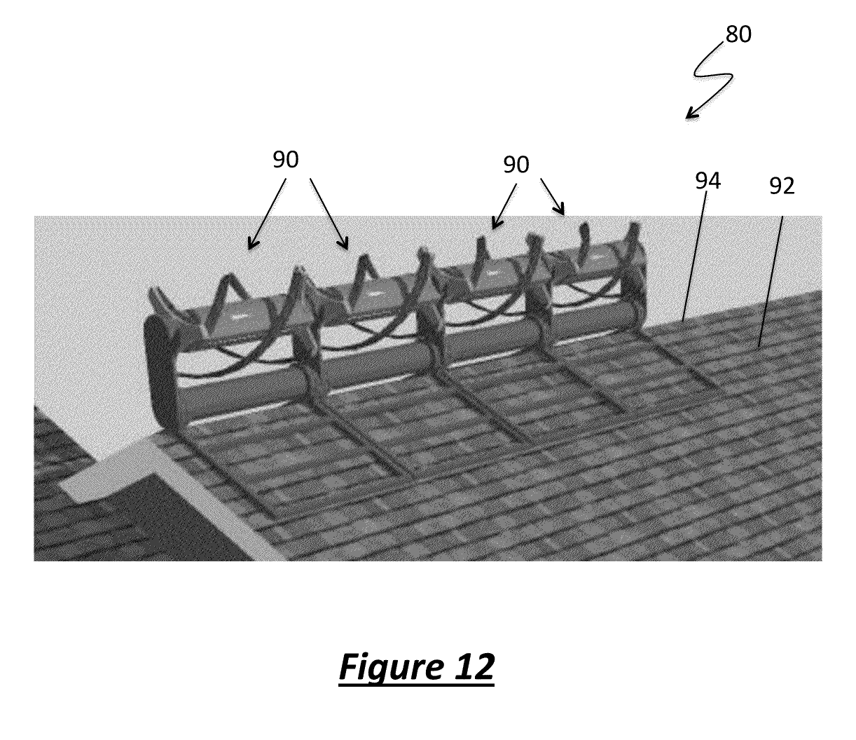

FIG. 12 is a perspective view of an arrangement 80 for mounting another wind turbine or wind turbine assembly 90 according to another aspect of the invention. Though according to one aspect of the invention, one or more turbine assemblies 90 may be mounted to any conventional surface, for example, a horizontally or vertically oriented surface, in the aspect shown in FIG. 12, a plurality of turbine assemblies 90 are mounted upon the surface of a roof 92, specifically, to a ridge 94 of roof 92 of a residence. According to this aspect of the invention, the position of turbine assembly 90 upon roof 92 enhances the likelihood that turbine assembly 90 will be exposed to wind, for example, to sufficient wind, to capture sufficient wind energy to generate electrical energy.

As shown in FIG. 12, in one aspect, a wind turbine as disclosed herein may be provided with a 7 means for directing the wind, for example, a surface positioned to capture and direct the wind toward the cylindrical airfoil.

In addition, according to an aspect of the invention, wind turbine assembly 90 shown in FIG. 12 (or any of the wind turbines or wind turbine assemblies disclosed herein) may include a means for directing wind to provide the flow of air to wind turbine assembly 90. For instance, in one aspect, a surface adjacent to wind turbine assembly 90 may be provided or positioned to assist in capturing and/or directing and/or promoting the flow of wind toward wind turbine assembly 90, for example, one or more baffles or deflectors may be positioned and appropriately oriented to deflect wind toward wind turbine assembly 90. The surface may be a baffle or deflector, for example, a flat, radiused, or otherwise curved baffle or deflector. In the aspect of the invention shown in FIG. 12, the surface of roof 92 may aid and/or promote the channeling or directing of wind toward turbine assemblies 90 to further enhance the likelihood of generating electrical energy.

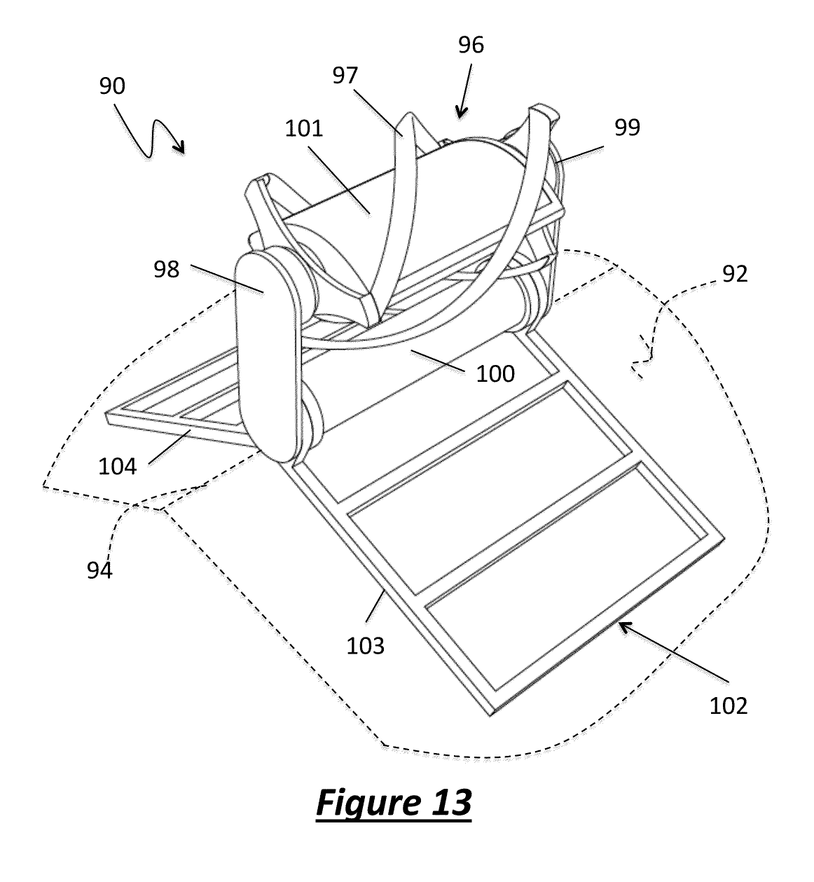

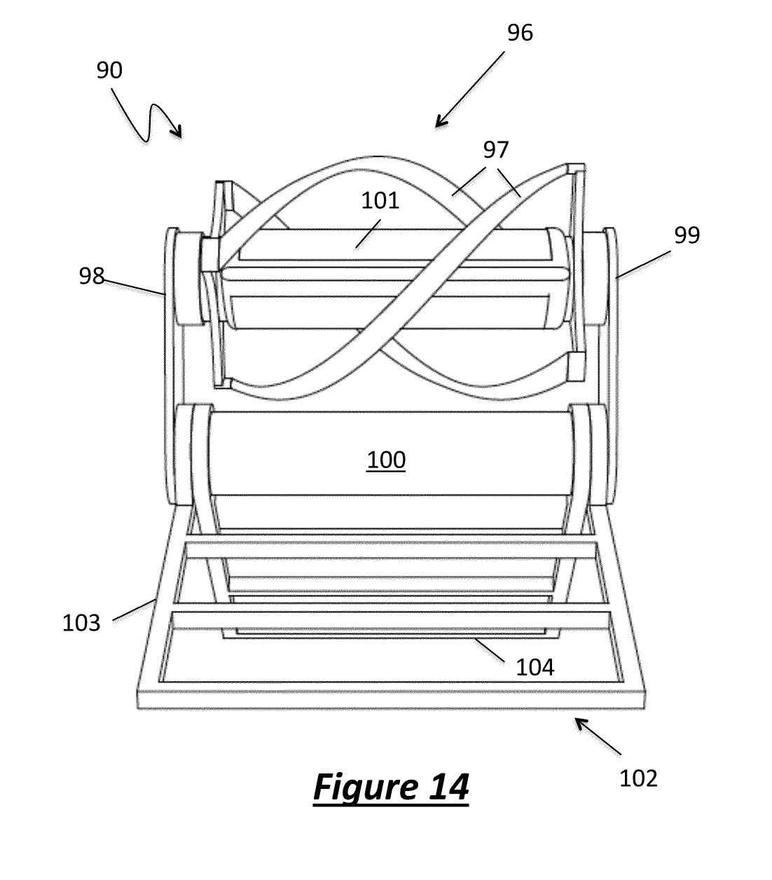

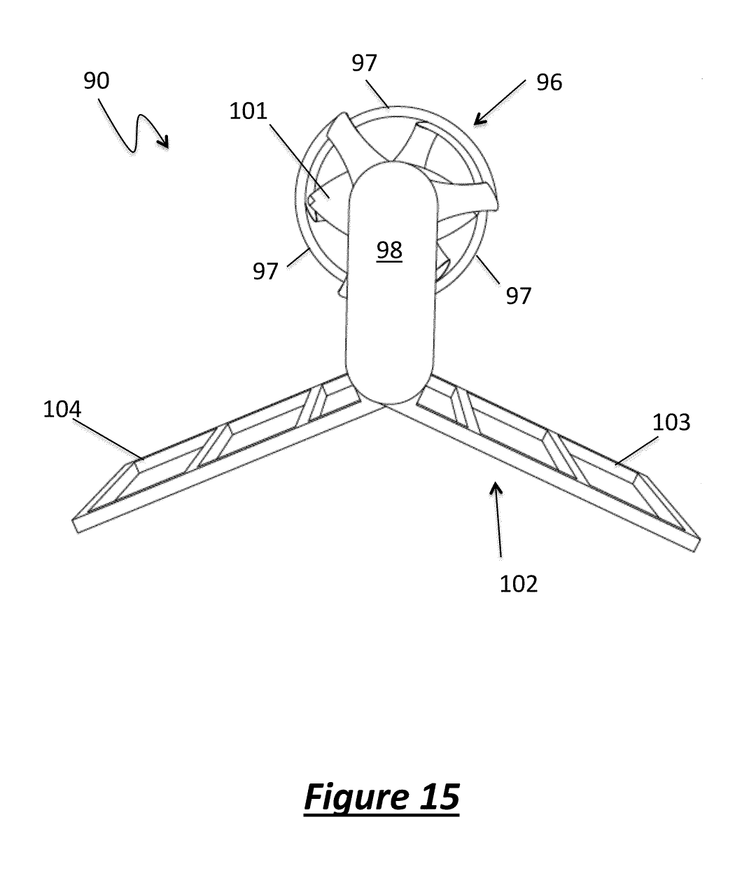

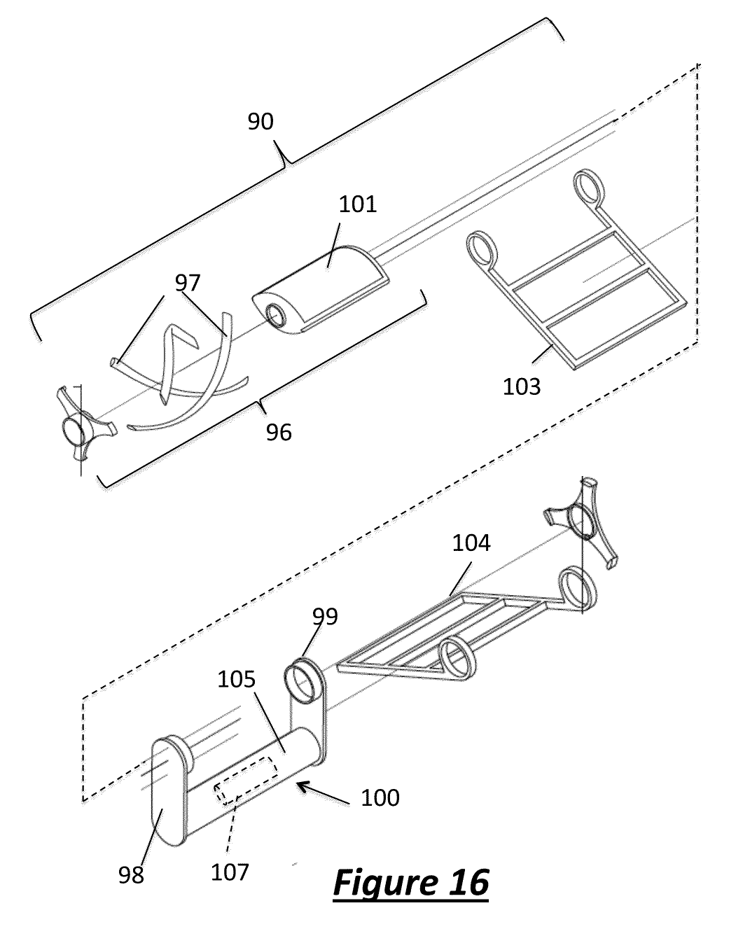

FIG. 13 is a perspective view of the wind turbine or wind turbine assembly 90 shown in FIG. 12, including illustrating roof 92 and ridge 94 in phantom for reference. FIG. 14 is a front elevation view of a wind turbine assembly 90 shown in FIG. 13, showing some perspective, and FIG. 15 is a left side elevation view of a wind turbine assembly 90 shown in FIG. 13, also showing some perspective, the right side elevation view being a mirror image thereof. FIG. 16 is an exploded perspective view of the wind turbine assembly 90 shown in FIG. 12

As shown in FIGS. 13 through 16, turbine assembly 90 includes a turbine 96, for example, a turbine similar or substantially identical to turbine 10, 30, 40, or 50 disclosed herein, lateral turbine mounting assemblies 98 and 99, generator housing 100, and turbine support assembly 102. As is typical of aspects of the invention disclosed herein, turbine 96 includes a plurality of airfoil blades 97 rotatably mounted to lateral mounting assemblies 98 and 99, and a cylindrical airfoil 101, which may be stationery or rotatably mounted to lateral mounting assemblies 98 and 99.

As also shown in FIG. 16, generator housing 100 may comprise a hollow cylindrical housing 105, for example, a circular cylindrical housing, though a polygonal or elliptical cylindrical housing may be used, and contain one or more electrical generators 107 adapted to be coupled and driven by turbine assembly 96, for example, by airfoil rotors 97 and/or cylindrical airfoil 101. As shown in FIGS. 12-14, cylindrical housing 105 may typically be mounted to support assembly 102, for example, by conventional means. As shown in FIG. 16, in one aspect, the one or more generators 107 may be driven by a drive mechanism (not shown) coupled to turbine assembly 96, for example, turbine mounting assemblies 98 and 99 may contain one or more gears, belts and sheaves, or chains and sprockets, among other drive mechanisms, with associated bearings and seals as is typically desired in the art.

As shown in FIGS. 12-16, support assembly 102 may comprise two or more sub-assemblies 103 and 104 which are adapted to engage a surface, for example, roof 92, to support and orient turbine assembly 96 as desired, for example, in the path of a prevailing wind stream.

In one aspect, the wind turbine or wind turbine assemblies 10, 30, 50, 60, 70, 80 and 90 shown in FIGS. 1-16 are marketed under the trademark “HelixOrb” by Nebula Energy Inc. of East Hartford, Conn.

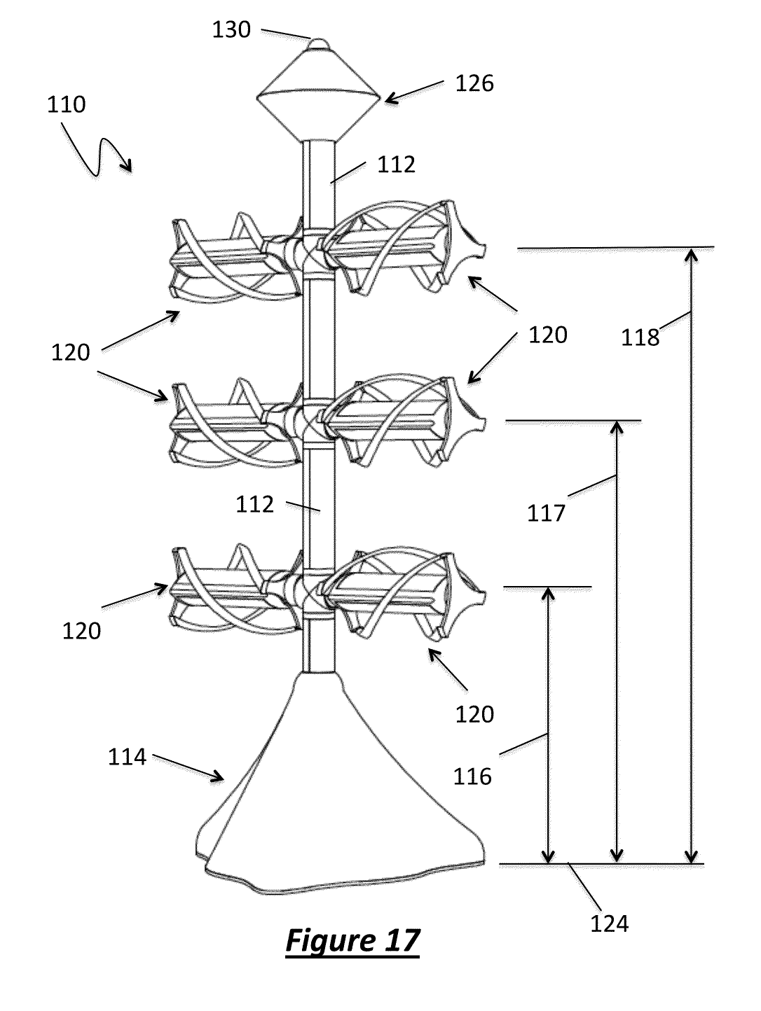

FIG. 17 is a perspective view of a tower assembly 110 having a plurality of wind turbines 120 according to one aspect of the invention. Wind turbines 120 may comprise one or more of the wind turbines 10, 30, 40, and 50 disclosed herein. Tower assembly 110 may be similar to and have one or more of the attributes of tower assembly 10 disclosed in copending U.S. application Ser. No. 13/676,068, the disclosure of which is incorporated by reference herein in its entirety. For example, in one aspect, tower assembly 110 shown in FIG. 17 may be a wind turbine containing and/or photovoltaic module containing tower assembly marketed under the trademark “SolarzTree” by Nebula Energy Inc. of East Hartford, Conn.

As shown in FIG. 17, tower assembly 110 may typically include an elongated pole, shaft, or column 112 mounted in a base assembly 114 adapted to support the pole 112 and the plurality of wind turbines 120. Wind turbines 120 may be pivotally mounted to the pole 112 at a plurality of elevations 116, 117, and 118, for example, from a datum or a ground level 124. In the aspect of the invention shown in FIG. 17, tower assembly 110 includes six (6) wind turbines 120; however, according to aspects of the invention, tower assembly 110 may include one (1) or more wind turbines 120, for example, two (2) or more, or three (3) or more, or twelve (12) or more wind turbines 120, for instance, depending upon the available space and/or wind capacity, among other things, of the site where tower 110 is located. The height of tower no may vary depending upon the parameters of the installation; however, the height of tower no may vary from about 10 feet to about 100 feet, but typically is between about 20 feet and about 40 feet.

In one aspect, wind turbines 120 may include at least some PV devices, for example, one or more wind turbines 120 may comprise wind turbine 50 disclosed in FIGS. 8 and 9 herein, and include PV devices 52. Moreover, in one aspect, one or more wind turbines 120 may include solar concentrator and heat exchanger assemblies disclosed in application Ser. No. 13/676,068 (by reference number 44) having the arrangement of PV devices (40) and/or reflective surfaces (42) disclosed therein adapted to reflect sunlight onto the plurality of PV devices (40) while capturing at least some solar energy as heat absorbed by a fluid passing through the solar concentrator and heat exchanger assembly (44).

In one aspect of the invention, wind turbines 120 of tower assembly 110 may be pivotally mounted to pole 112, that is, adapted to rotate about an axis. Though not shown in FIG. 17, in one aspect, tower assembly 110 may include a drive mechanism adapted to rotate each of the pivotally mounted wind turbines 120, for example, about a horizontal axis. Accordingly, aspects of the invention may include the capability to rotate one or more of the wind turbines 120 to vary or optimize the orientation of the wind turbines 120 to, for example, enhance the wind energy and/or solar energy collecting capacity of the tower 110, for instance, as wind currents vary and/or the elevation of the sun varies during the day or throughout the year. In addition, as discussed more fully in copending application Ser. No. 13/676,068, according to another aspect of the invention, tower 110 may also be adapted to vary the orientation of pole 112, for example, with respect to base assembly 114, for instance, to tilt and/or rotate pole 112, in order to further enhance the wind energy collecting capability and/or solar energy collecting capability of tower 110 as wind currents vary and/or as the elevation of the sun varies during the day or throughout the year. For instance, the base assembly 114 may be adapted to pivotally and rotationally support pole 112 whereby the orientation of wind turbines 120 may be varied.

As also shown in FIG. 17, tower 110 may also include a light assembly 126 mounted to pole 112, for example, to the top of pole 112. As shown and described more completely in co-pending application Ser. No. 13/676,068, according to another aspect of the invention, light assembly 126 may include a plurality of light sources, for example, LED light sources, and may be powered by the solar energy captured by one or more PV devices in wind turbines 120. Light assembly 126 may also include one or more detectors or cameras 130, for example, a detector adapted to detect the amount of wind or sunlight available or a security camera adapted to detect images of the area about the tower 110, for example, in an adjacent playground, park, parking lot or parking garage.

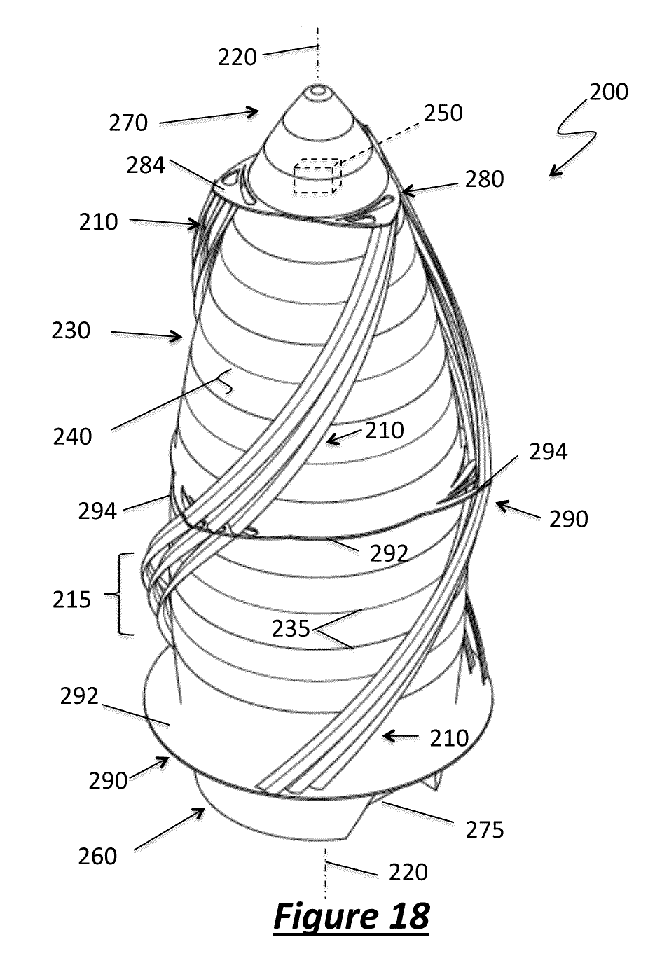

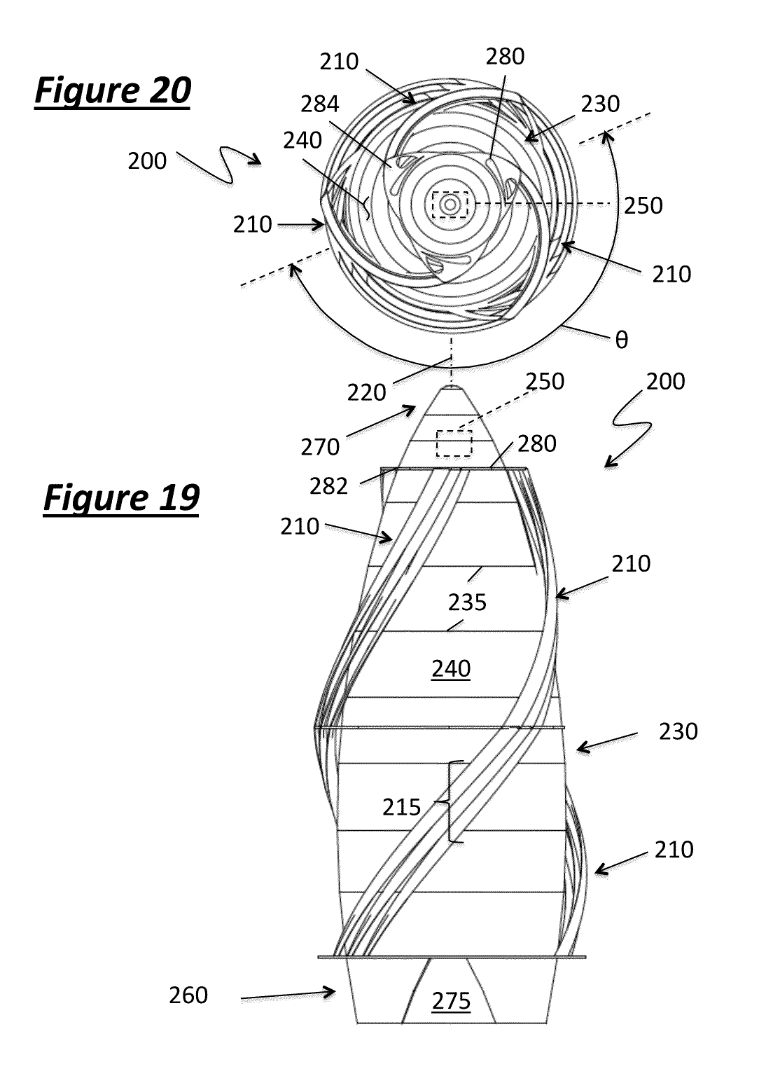

FIG. 18 is a perspective view of one energy capturing assembly 200 according to another embodiment of the invention. FIG. 19 is a side elevation view of energy capturing assembly 200 shown in FIG. 18, and FIG. 20 is a top plan view of energy capturing assembly 200 shown in FIG. 18. As shown in FIGS. 18 through 20, assembly 200 includes a plurality of airfoil blades 210 mounted for rotation about an axis 220 and a structure 230, for example, a building, a residence, a tower, a tank, or a vessel, among other structures, having an outer surface 240 shaped to direct a flow of fluid, for example, water or air, toward the plurality of helical airfoil blades 210. Though shown directed substantially vertically, axis 220 may be directed any appropriate orientation based upon the desired installation, for example, substantially horizontally or substantially vertically, among other orientations.

The assembly 200 typically includes at least one electrical generator 250, for example, mounted within structure 230, operatively connected to the plurality of rotating airfoil blades 210. The shape and size of airfoil blades 210 and structure 230 reflect the shape, relationship, and function of the airfoil blades and cylindrical airfoils disclosed throughout this specification. That is, the relationship and shape of structure 230 and airfoil blades 210 promote the directing and/or concentrating of fluid flow toward airfoil blades 210 to provide an enhanced energy-capturing capacity. The specific shape of assembly 200 shown in FIGS. 18 through 20 is inspired by the skyscraper “30 St. Mary Axe,” the second tallest building in London (which, due to its unique shape, is popularly referred to as “the Gherkin”). The Gherkin is described at the website “http://www.30stmaryaxe.com,” which is incorporated by reference herein.

As shown in FIGS. 18 through 20, in this aspect, the plurality of airfoil blades 210 of assembly 200 may comprise a plurality of sets 215 of airfoil blades 210. As shown, each set 215 of blades 210 may comprise one or more, or a plurality of, individual blades 210. In the aspect shown in FIGS. 18 through 20, each set 215 comprises three individual blades 210, though aspects of the invention may have 2 or more, or four or more individual blades 210 per set 215. According to aspects of the invention, the set 215 of airfoil blades 210 (and any and all sets of airfoil blades disclosed herein) provide advantageous features for the capture or extraction of torque from a fluid, such as, wind, and enhances the energy capturing capacity. First, since the airfoil blades 210 of each set 215 are offset from each other, for example, much like the wings of a “triplane” airplane, more fluid energy can be captured, for example, more of the wind energy that is accelerated by the surface 240 of structure 230. In addition, as the fluid is being accelerated around the structure 230, having three airfoil blades 210 enhances the potential to capture or extract more fluid energy from the accelerating fluid, as well as to create a trap for the fluid until all the energy in the fluid can be is extracted. In addition, the helical airfoil blades 210, the offset of the blades 210, and the airfoil blade geometry allows airfoil blades 210 to “surf” the accelerated fluid and maximize the extraction of energy from the fluid because, it is believed, that the fluid would be channeled around the curve of the structure 230 when depleted of its energy. The offset airfoil blades 210 may also serve to reduce the friction of the airfoil blades 210 when rotating by allowing the fluid to flow freely through the offset slots between airfoil blades 210. Additionally, according to aspects of the invention, the offset airfoil blades 210 also serve to trap the fluid (for example, air) that gets directed around the surface 240 by passing the accelerated fluid from the first inner blade of the set 215 to the next middle blade of the set 215 then to the final outer blade of the set 215. It is understood that by the time the fluid reaches the third outer blade of the set 215 most of the energy that can be extracted from the fluid has been extracted.

As shown in FIGS. 18 through 20, blades 210 may typically be “helical” in shape, for example, extending from about the top of assembly 200 to about the bottom of assembly 200 while twisting through an angle θ (see FIG. 20). The angle θ may range from about 15 degrees to about 360 degrees or more (depending upon the dimensions of assembly 200 and the available fluid flow), but angle θ may typically be between about 90 degrees and about 270 degrees, for example, between about 150 degrees to about 210 degrees, for instance, about 180 degrees as shown in FIGS. 18 through 20. In the aspect shown in FIGS. 18 through 20, the direction of the helix (or “twist”) is shown in a clockwise direction (as viewed from the top view of FIG. 20). However, it is envisioned that for the embodiment shown in FIGS. 18 through 20 (and for any and all embodiments disclosed herein), the direction of the helix may also be counter-clockwise (as viewed in FIG. 20). Though in one aspect, angle θ may be substantially constant for each set 215 of blades 210, as shown in FIGS. 18 through 20, the angle θ may also vary, for example two or more sets 215 of blades 20 may twist through a different angle θ. As also shown in FIGS. 18 through 20, in one aspect, the blades 210 may be evenly distributed about structure 230, for example, evenly distributed about the circumference of structure 230. For instance, as shown in FIGS. 18 through 20, three sets 215 of blades 210 are evenly distributed, at about an angle of 120 degrees, about structure 230. In one aspect, sets 215 of blades 210 may not be evenly distributed about structure 230.

In the aspect of the invention shown in FIGS. 18 through 20, structure 230 may typically be a cylindrical structure having outer surface 240 and blades 210 shaped and adapted to conform to the shape of outer surface 240. For example, in FIGS. 18 through 20, structure 230, comprises a somewhat parabolic or “bullet-like” shape. However, according to other aspects of the invention, for example, as shown in FIGS. 18 through 20, structure 230 and surface 240 may comprise any radially symmetric shape, for example, radially symmetric about axis 220. The surface 240 may typically be smooth and continuous, for example, to enhance the desired channeling and/or directing of wind flow. However, surface 240 may be interrupted or discontinuous due to the presence of windows and/or other structural features which may have minimal or no impact upon the gross function of directing fluid flow. Though surface 240 may typically be smooth and continuous, in FIGS. 18 through 20, horizontal lines 235 are presented to represent individual segments or portions of structure 230 that may be provided to facilitate manufacture and/or construction of structure 230.

Though in one aspect, the structure 230 may also be symmetric about a mid-plane, that is, having a top and bottom of substantially the same shape, as suggested by the shape of structure 230 shown in FIGS. 18 through 20, for example, in order to provide appropriate structural support and/or access by personnel, structure 230 may typically comprise a base 260 and an apex 270 opposite the base 260. Base 260 may typically be adapted to support assembly 200, for example, designed to mount structure 230 to a surface, for example, to ground, to a roof top, and/or to a support structure (not shown). As shown in FIGS. 18 through 20, base 260 may include one or more access openings, portals, window, or doors 275, for example, to provide access and entry for personnel, for example, technicians attending to assembly 200, residents residing in assembly 200, or workers occupying assembly 200, among others. Access openings, portals, or doors 275 may also be provided to permit access to wiring and plumbing, for example, for power transmission lines adapted to transmit the electric power generated by assembly 200.

Apex 270, as shown in FIG. 18 through 20, may comprise a relative “peak” where the shape of structure 230 comes to somewhat of a “point,” for example, in conformance to the desired shape of surface 240. However, in one aspect, apex 270 may not come to a “point,” but may be adapted to support blades 210 while conforming to the desired shape of surface 240. For example, apex 270 may comprise a surface, for instance, a generally flat surface, having one or more structures adapted to operatively mount airfoil blades 210 to assembly 200 and, possibly, house or support electrical generator 250, among other equipment.

According to one aspect, the plurality of airfoil blades includes at least one end adapted to be mounted to or about apex 270 of structure 230. For example, as shown in FIGS. 18 through 20, apex 270 may include a rotor 280 mounted for rotation about axis 220 and adapted to engage airfoil blades 210. Rotor 280 may typically be operatively connected, for example, directly coupled, to electrical generator 250. Though rotor 280 is shown positioned at or toward the apex 270 of structure 230, rotor 280 may be positioned and adapted to be rotated at any axial position along structure 230, for example, adjacent or in base 260, or anywhere between base 260 and apex 270. In one aspect, two or more rotors 280 may be mounted for rotation along structure 230 and be operatively connected to one or more electrical generators 250.

Though rotor 280 may comprise any shape adapted to rotatably mount to structure 230 and engage blades 210, in the aspect shown in FIGS. 18 through 20, rotor 280 may comprise a substantially flat plate 282 having lobes 284. Lobes 284, for example, evenly distributed lobes 284, are adapted to engage and support blades 210, for example, by conventional means, for instance, by mechanical fasteners (not shown) and/or welding.

Though in one aspect, airfoil blades 210 may be substantially mounted to and supported by only one rotor 280, typically, blades 210 may also be mounted to and supported by one or more support rings 290. In the aspect shown in FIGS. 18 through 20, assembly 200 includes two support rings 290 evenly spaced along structure 230. Support rings 290 may comprise a substantially flat plate 292 having lobes 294, for example, evenly distributed lobes 294, and are adapted to engage and support blades 210, for example, by conventional means. Though in one aspect, rings 290 may be operatively connected to an electrical generator, in the aspect shown, rings 290 are adapted to rotate about structure 230 as impelled by airfoil blades 210. Accordingly, in one aspect, rings 290 may be mounted for rotation by means of friction reducing devices (not shown), for example, roller bearings, journal bearings, friction reducing materials (such as, DuPont's Teflon® polytetrafluoroethylene (PTFE) or Saint-Gobain's Rulon® PTFE or their equivalents), and/or a lubricated surface.

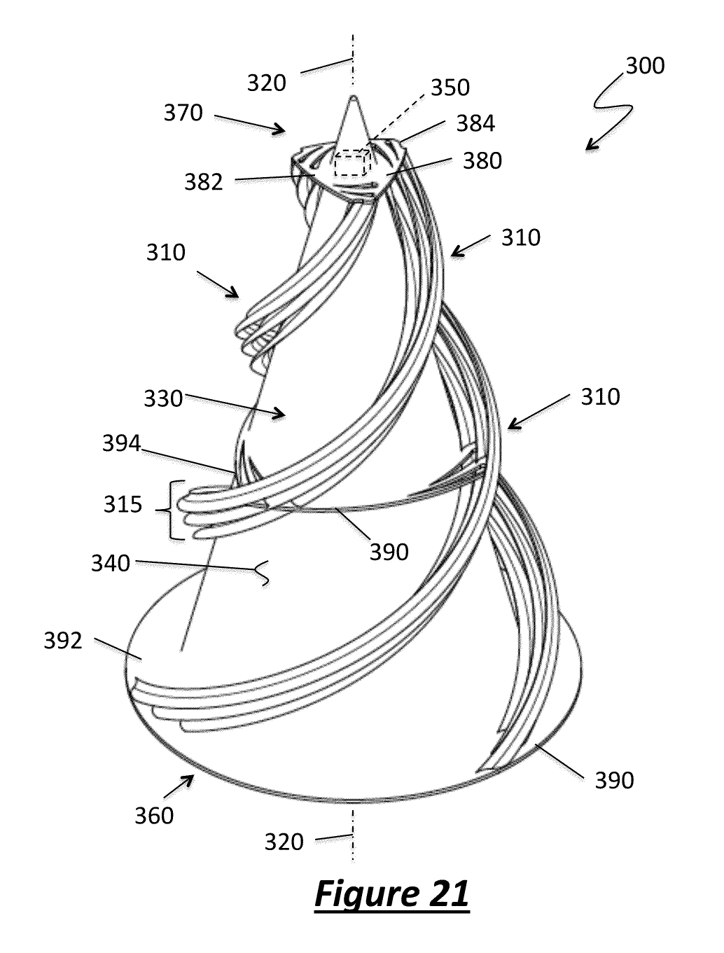

According to aspects of the invention, the outer surface 240 of structure 230 may comprise any shaped surface adapted to channel and/or direct a fluid, for example, water or air, and may include a cylindrical outer surface, for example, a circular cylindrical outer surface, a conical outer surface, a spherical outer surface, an ellipsoidal outer surface, a parabolic outer surface, or a hyperbolic outer surface, among others. FIGS. 21 through 28 illustrate the shapes of structures of two further embodiments of the invention.

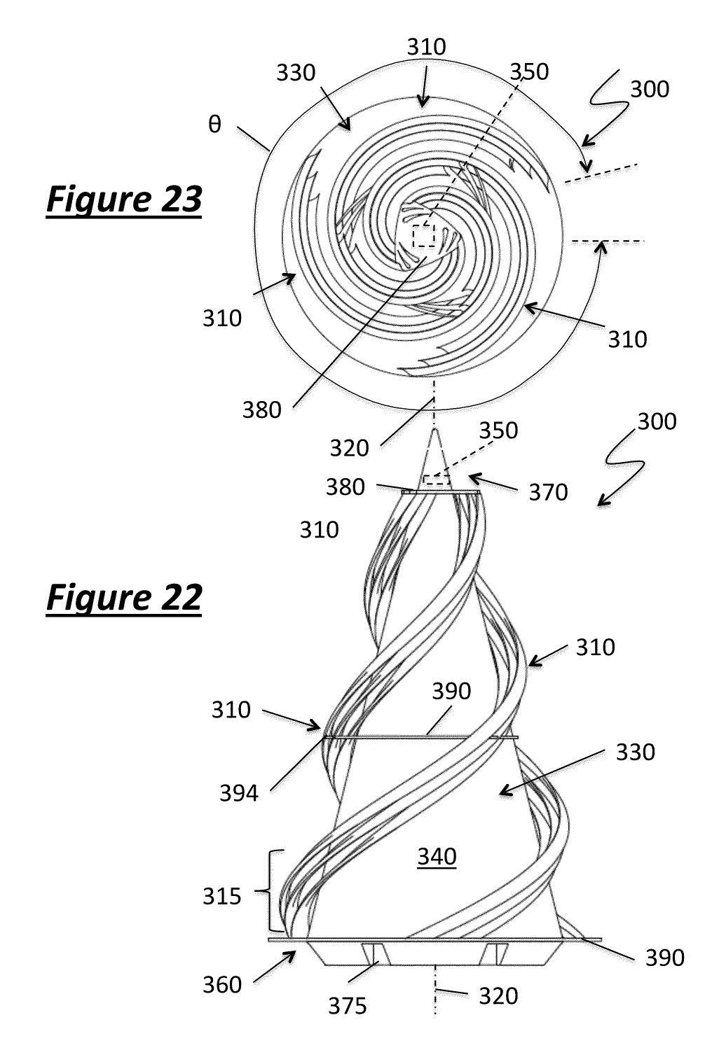

FIG. 21 is a perspective view of another energy capturing assembly 300 according to another embodiment of the invention having a conical shape. FIG. 22 is a side elevation view of the energy capturing assembly 300 shown in FIG. 21, and FIG. 23 is a top plan view of the energy capturing assembly 300 shown in FIG. 21. The components, functions, and features of assembly 300 are similar to, if not identical to, the components, functions, and features of assembly 200 shown in FIGS. 18 through 20, and are not elaborated upon. Similar to assembly 200, assembly 300 includes a plurality of airfoil blades 310 mounted for rotation about an axis 320 and a structure 330, for example, a building, a residence, a tower, a tank, or a vessel, among other structures, having an outer surface 340 (in this aspect, a conical surface) shaped to direct a flow of fluid, for example, water or air, toward the plurality of helical airfoil blades 310. Though shown directed substantially vertically, axis 320 may be directed any appropriate orientation based upon the desired installation, for example, substantially horizontally or substantially vertically, among other orientations.

The assembly 300 typically includes at least one electrical generator 350, for example, mounted within structure 330, operatively connected to the plurality of rotating airfoil blades 310. The shape and size of airfoil blades 310 and structure 330 reflect the shape, relationship, and function of the airfoil blades and cylindrical airfoils disclosed throughout this specification. That is, the relationship and shape of structure 330 and airfoil blades 310 promote the directing and/or concentrating of fluid flow toward airfoil blades 310 to provide an enhanced energy-capturing capacity. As shown in FIGS. 21 through 23, in this aspect, the plurality of airfoil blades 310 of assembly 300 may comprise a plurality of sets 315 of airfoil blades 310. Each set 315 of blades 310 may comprise one or more, or a plurality of, individual blades 310. In the aspect shown in FIGS. 21 through 23, each set 315 comprises three individual blades 310, though aspects of the invention may have 2 or more, or four or more individual blades 310 per set 315.

Similar to blades 210, as shown in FIGS. 21 through 22, blades 310 may typically be “helical” in shape, twisting through an angle θ. The angle θ may range from about 15 degrees to about 360 degrees or more (depending upon the dimensions of assembly 300 and the available fluid flow), but angle θ for assembly 300 may typically be between about 180 degrees and about 540 degrees, for example, between about 210 degrees to about 450 degrees, for instance, about 330 degrees as shown in FIGS. 21 through 23. Though in one aspect, angle θ may be substantially constant for each set 315 of blades 310, as shown in FIGS. 21 through 23, the angle θ may also vary, for example two or more sets 315 of blades 310 may twist through a different angle θ. The blades 310 may be evenly distributed about structure 330, for example, as shown in FIGS. 21 through 23, three sets 315 of blades 310 are evenly distributed, at about an angle of 120 degrees, about structure 330. In one aspect, sets 315 of blades 310 may not be evenly distributed about structure 330.

The surface 340 may typically be smooth and continuous, for example, to enhance the desired channeling and/or directing of wind flow. However, surface 340 may be interrupted or discontinuous due to the presence of windows and/or other structural features which may have minimal or no impact upon the gross function of directing fluid flow. Though surface 340 may typically be smooth and continuous, surface 340 may be comprised of individual segments or portions of structure 330 that may be provided to facilitate manufacture and/or construction of structure 330.

Though in one aspect, the structure 330 may also be symmetric about a mid-plane, that is, having a top and bottom of substantially the same shape, as suggested by the shape of structure 330 shown in FIGS. 21 through 23, for example, in order to provide appropriate structural support and/or access by personnel, structure 330 may typically comprise a base 360 and an apex 370 opposite the base 360. Base 360 may typically be adapted to support assembly 300, for example, designed to mount structure 330 to a surface, for example, to ground, to a roof top, and/or to a support structure (not shown). As shown in FIGS. 21 through 23, base 360 may include one or more access openings, portals, window, or doors 375, for example, to provide access and entry for personnel, for example, technicians attending to assembly 300, residents residing in assembly 300, or workers occupying assembly 300, among others. Access openings, portals, or doors 375 may also be provided to permit access to wiring and plumbing, for example, for power transmission lines adapted to transmit the electric power generated by assembly 300.

Apex 370, as shown in FIG. 21 through 23, may comprise a relative “peak” where the shape of structure 330 comes to somewhat of a “point,” for example, in conformance to the desired shape of surface 340. However, in one aspect, apex 370 may not come to a “point,” but may be adapted to support blades 310 while conforming to the desired shape of surface 340. For example, apex 370 may comprise a surface, for instance, a generally flat surface, having one or more structures adapted to operatively mount airfoil blades 310 to assembly 300 and, possibly, house or support electrical generator 350, among other equipment.

According to one aspect, the plurality of airfoil blades 310 include at least one end adapted to be mounted to or about apex 370 of structure 330. For example, as shown in FIGS. 21 through 23, apex 370 may include a rotor 380 mounted for rotation about axis 320 and adapted to engage airfoil blades 310. Rotor 380 may typically be operatively connected, for example, directly coupled, to electrical generator 350. Though rotor 380 is shown positioned at or toward the apex 370 of structure 330, rotor 380 may be positioned and adapted to be rotated at any axial position along structure 330, for example, adjacent or in base 360, or anywhere between base 360 and apex 370. In one aspect, two or more rotors 380 may be mounted for rotation along structure 330 and be operatively connected to one or more electrical generators 350.

Though rotor 380 may comprise any shape adapted to rotatably mount to structure 330 and engage blades 310, in the aspect shown in FIGS. 21 through 23, rotor 380 may comprise a substantially flat plate 382 having lobes 384. Lobes 384, for example, evenly distributed lobes 384, are adapted to engage and support blades 310, for example, by conventional means, for instance, by mechanical fasteners (not shown) and/or welding.

Though in one aspect, airfoil blades 310 may be substantially mounted to and supported by only one rotor 380, typically, blades 310 may also be mounted to and supported by one or more support rings 390. In the aspect shown in FIGS. 21 through 23, assembly 300 includes two support rings 390 evenly spaced along structure 330. Support rings 390 may comprise a substantially flat plate 392 having lobes 394, for example, evenly distributed lobes 394, and are adapted to engage and support blades 310, for example, by conventional means. Though in one aspect, rings 390 may be operatively connected to an electrical generator, in the aspect shown, rings 390 are adapted to rotate about structure 330 as impelled by airfoil blades 310. Accordingly, in one aspect, rings 390 may be mounted for rotation by means of friction reducing devices (not shown), for example, roller bearings, journal bearings, friction reducing materials (such as, DuPont's Teflon® polytetrafluoroethylene (PTFE) or Saint-Gobain's Rulon® PTFE or their equivalents), and/or a lubricated surface.

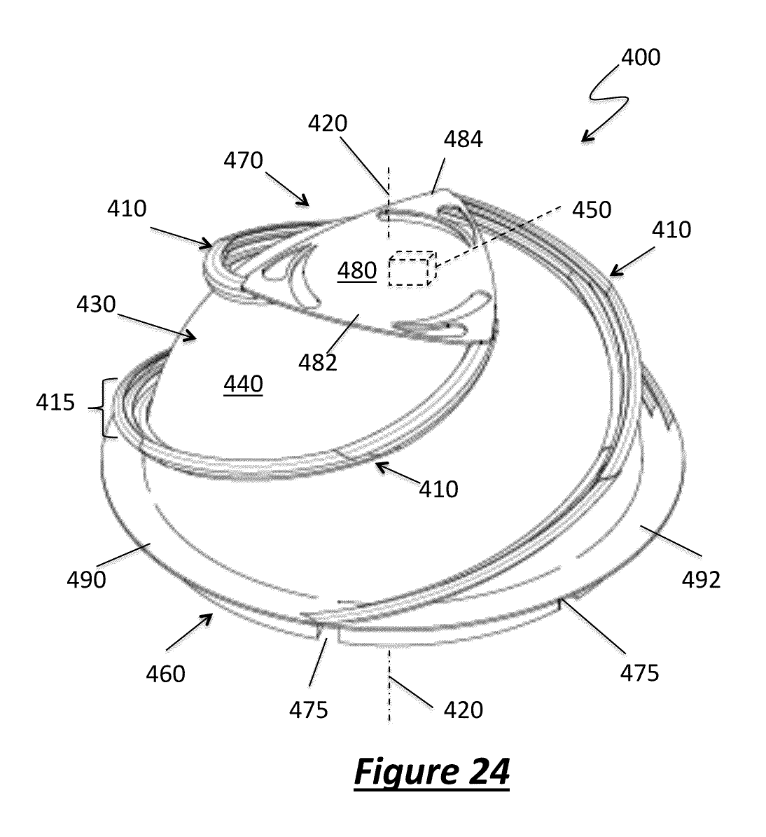

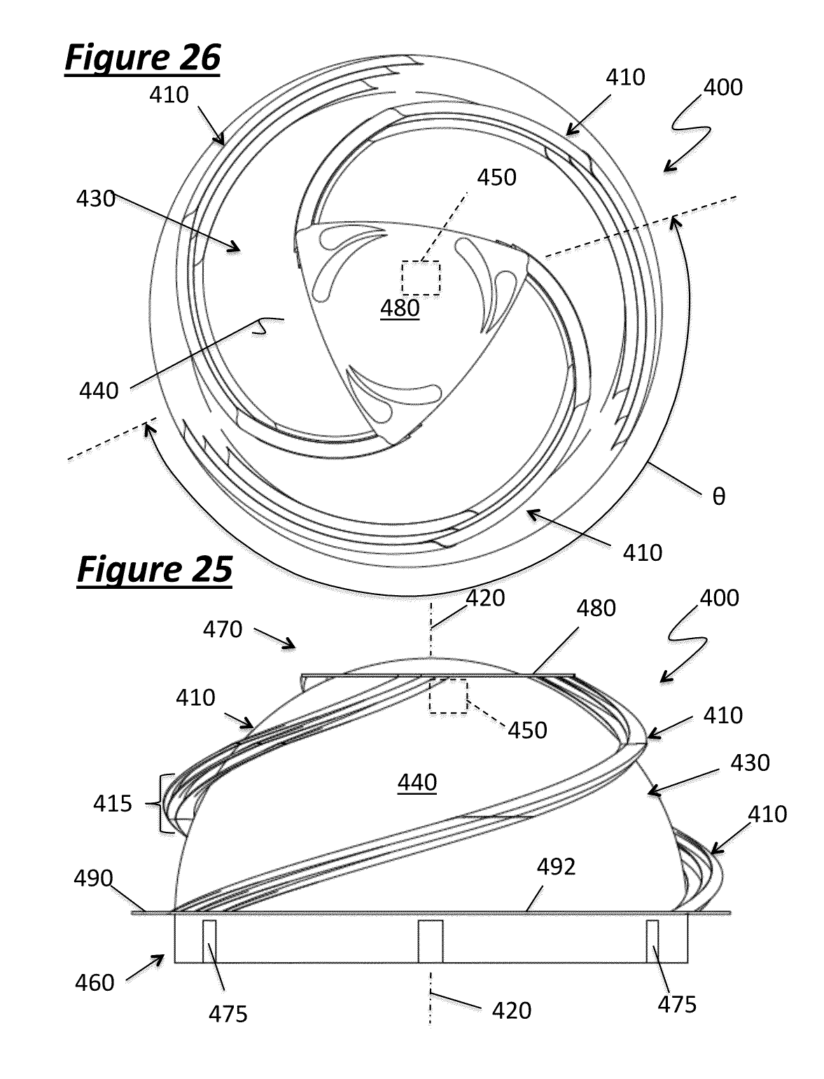

FIG. 24 is a perspective view of another energy capturing assembly 400 according to another embodiment of the invention having a hemispherical shape. FIG. 25 is a side elevation view of the energy capturing assembly 400 shown in FIG. 24, and FIG. 26 is a top plan view of the energy capturing assembly 400 shown in FIG. 24. The components, functions, and features of assembly 300 are similar to, if not identical to, the components, functions, and features of assembly 200 shown in FIGS. 18 through 20, and are not elaborated upon. Similar to assembly 200 and assembly 300, assembly 400 includes a plurality of airfoil blades 410 mounted for rotation about an axis 420 and a structure 430, for example, a building, a residence, a tower, a tank, or a vessel, among other structures, having an outer surface 440 (in this aspect, a hemispherical surface) shaped to direct a flow of fluid, for example, water or air, toward the plurality of helical airfoil blades 410. Though shown directed substantially vertically, axis 420 may be directed in any appropriate orientation based upon the desired installation, for example, substantially horizontally or substantially vertically, among other orientations.

The assembly 400 typically includes at least one electrical generator 450, for example, mounted within structure 430, operatively connected to the plurality of rotating airfoil blades 410. Again, the shape and size of airfoil blades 410 and structure 430 reflect the shape, relationship, and function of the airfoil blades and cylindrical airfoils disclosed throughout this specification. That is, the relationship and shape of structure 430 and airfoil blades 410 promote the directing and/or concentrating of fluid flow toward airfoil blades 410 to provide an enhanced energy-capturing capacity. As shown in FIGS. 24 through 26, in this aspect, the plurality of airfoil blades 410 of assembly 400 may comprise a plurality of sets 415 of airfoil blades 410. Each set 415 of blades 410 may comprise one or more, or a plurality of, individual blades 410. In the aspect shown in FIGS. 24 through 26, each set 415 comprises three individual blades 410, though aspects of the invention may have 2 or more, or four or more individual blades 410 per set 415.

Similar to blades 210 shown in FIGS. 18 through 20 and blades 310 shown in FIGS. 21 through 23, blades 410 may typically be “helical” in shape, twisting through an angle θ (See FIG. 26). In the aspect shown in FIGS. 24 through 26, the angle θ may range from about 15 degrees to about 360 degrees or more (depending upon the dimensions of assembly 400 and the available fluid flow), but angle θ for assembly 400 may typically be between about 90 degrees and about 360 degrees, for example, between about 150 degrees to about 270 degrees, for instance, about 180 degrees as shown in FIGS. 24 through 26. Though in one aspect, angle θ may be substantially constant for each set 415 of blades 410, as shown in FIGS. 24 through 26, the angle θ may also vary, for example, two or more sets 415 of blades 410 may twist through a different angle θ. The blades 410 may be evenly distributed about structure 430, for example, as shown in FIGS. 24 through 26, three sets 415 of blades 410 are evenly distributed, at about an angle of 120 degrees, about structure 430. In one aspect, sets 415 of blades 410 may not be evenly distributed about structure 430.

The surface 440 may typically be smooth and continuous, for example, to enhance the desired channeling and/or directing of wind flow. However, surface 440 may be interrupted or discontinuous due to the presence of windows and/or other structural features which may have minimal or no impact upon the gross function of directing fluid flow. Though surface 440 may typically be smooth and continuous, surface 440 may be comprised of individual segments or portions of structure 430 that may be provided to facilitate manufacture and/or construction of structure 430.

Though in one aspect, the structure 430 may also be symmetric about a mid-plane, that is, having a top and bottom of substantially the same shape, for instance, spherical, as suggested by the shape of structure 430 shown in FIGS. 24 through 26, for example, in order to provide appropriate structural support and/or access by personnel, structure 430 may typically comprise a base 460 and an apex 470 opposite the base 460. Base 460 may typically be adapted to support assembly 400, for example, designed to mount structure 430 to a surface, for example, to ground, to a roof top, and/or to a support structure (not shown). As shown in FIGS. 24 through 26, base 460 may include one or more access openings, portals, window, or doors 475, for example, to provide access and entry for personnel, for example, technicians attending to assembly 400, residents residing in assembly 400, or workers occupying assembly 400, among others. Access openings, portals, or doors 475 may also be provided to permit access to wiring and plumbing, for example, for power transmission lines adapted to transmit the electric power generated by assembly 400.

Apex 470, as shown in FIG. 24 through 26, may comprise a relative “peak” where the shape of structure 430 comes to somewhat of a “point,” for example, in conformance to the desired shape of surface 440. However, in one aspect, apex 470 may not come to a “point,” but may be adapted to support blades 410 while conforming to the desired shape of surface 440. For example, apex 470 may comprise a surface, for instance, a generally flat surface, having one or more structures adapted to operatively mount airfoil blades 410 to assembly 400 and, possibly, house or support electrical generator 450, among other equipment.

According to one aspect, the plurality of airfoil blades 410 include at least one end adapted to be mounted to or about apex 470 of structure 430. For example, as shown in FIGS. 24 through 26, apex 470 may include a rotor 480 mounted for rotation about axis 420 and adapted to engage airfoil blades 410. Rotor 480 may typically be operatively connected, for example, directly coupled, to electrical generator 450. Though rotor 480 is shown positioned at or toward the apex 470 of structure 430, rotor 480 may be positioned and adapted to be rotated at any axial position along structure 430, for example, adjacent to or in base 460, or anywhere between base 460 and apex 470. In one aspect, two or more rotors 480 may be mounted for rotation along structure 430 and be operatively connected to one or more electrical generators 450.

Though rotor 480 may comprise any shape adapted to rotatably mount to structure 430 and engage blades 410, in the aspect shown in FIGS. 24 through 26, rotor 480 may comprise a substantially flat plate 482 having lobes 484. Lobes 484, for example, evenly distributed lobes 484, are adapted to engage and support blades 410, for example, by conventional means, for instance, by mechanical fasteners (not shown) and/or welding.

Though in one aspect, airfoil blades 410 may be substantially mounted to and supported by only one rotor 480, typically, blades 410 may also be mounted to and supported by one or more support rings 490. In the aspect shown in FIGS. 24 through 26, assembly 400 includes one support ring 490, though a plurality of evenly spaced rings 490 may be provided along structure 430. Support rings 490 may comprise a substantially flat plate 492 having lobes (not shown), for example, evenly distributed lobes, and are adapted to engage and support blades 410, for example, by conventional means. Though in one aspect, rings 490 may be operatively connected to an electrical generator, in the aspect shown, ring 490 is adapted to rotate about structure 430 as impelled by airfoil blades 410. Accordingly, in one aspect, ring 490 may be mounted for rotation by means of friction reducing devices (not shown), for example, roller bearings, journal bearings, friction reducing materials (such as, DuPont's Teflon® polytetrafluoroethylene (PTFE) or Saint-Gobain's Rulon® PTFE or their equivalents), and/or a lubricated surface.

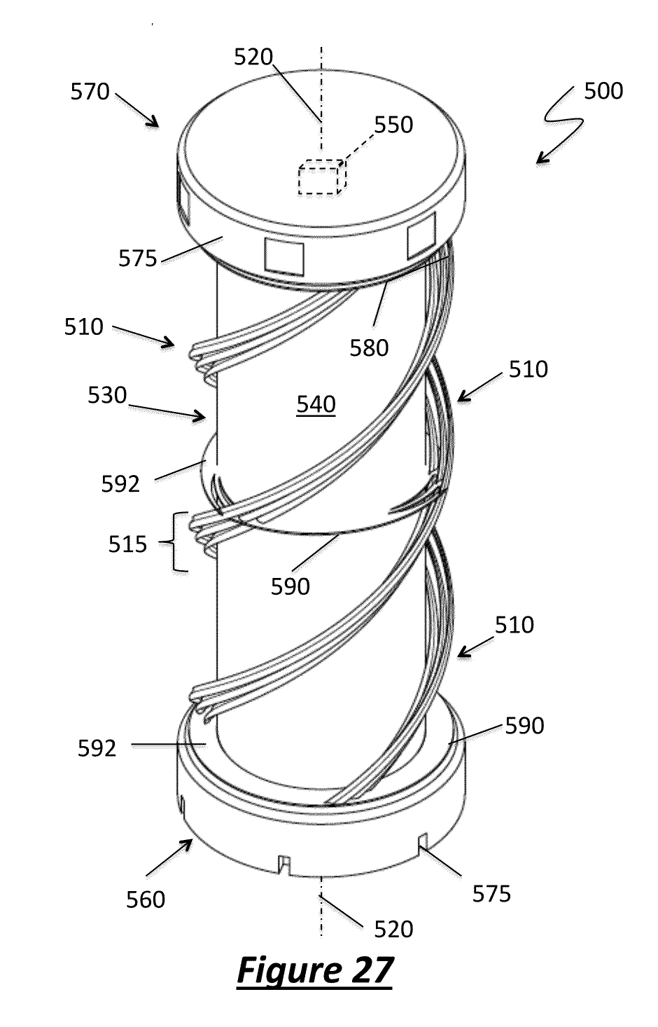

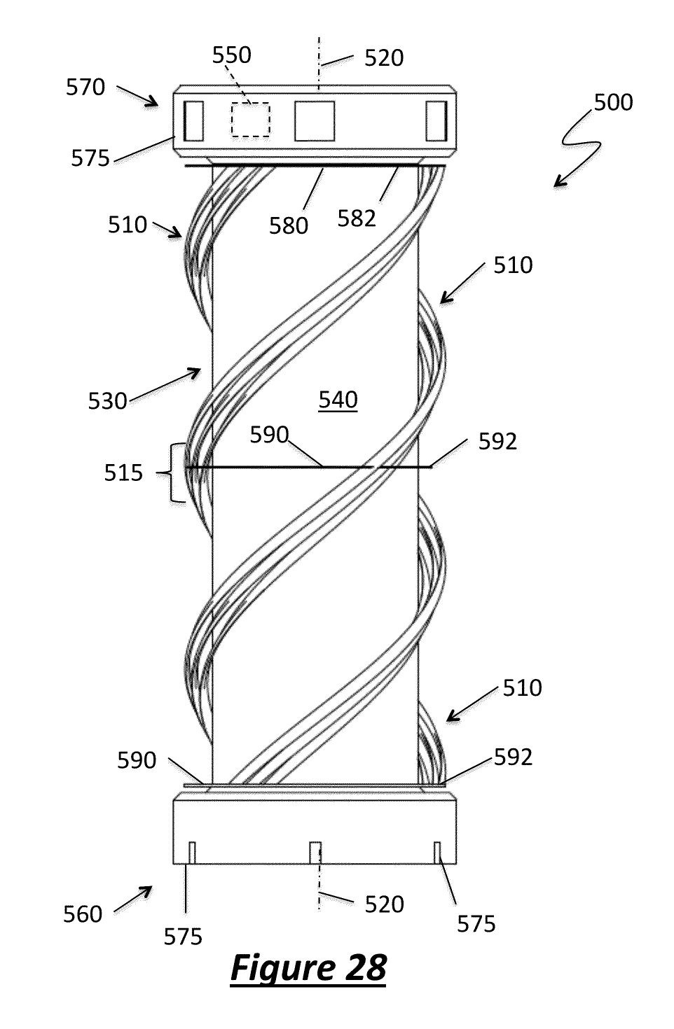

FIG. 27 is a perspective view of another energy capturing assembly 500 according to another embodiment of the invention having a circular cylindrical shape. FIG. 28 is a side elevation view of the energy capturing assembly 500 shown in FIG. 27. The components, functions, and features of assembly 500 are similar to, if not identical to, the components, functions, and features of assembly 200 shown in FIGS. 18 through 20, and are not elaborated upon. Similar to assembly 200, assembly 300, and assembly 400, assembly 500 includes a plurality of airfoil blades 510 mounted for rotation about an axis 520 and a structure 530, for example, a building, a residence, a tower, a tank, or a vessel, among other structures, having an outer surface 540 (in this aspect, a circular cylindrical surface) shaped to direct a flow of fluid, for example, water or air, toward the plurality of helical airfoil blades 510. Though shown directed substantially vertically, axis 520 may be directed in any appropriate orientation based upon the desired installation, for example, substantially horizontally or substantially vertically, among other orientations.

The assembly 500 typically includes at least one electrical generator 550, for example, mounted within structure 530, operatively connected to the plurality of rotating airfoil blades 510. Again, the shape and size of airfoil blades 510 and structure 530 reflect the shape, relationship, and function of the airfoil blades and cylindrical airfoils disclosed throughout this specification. That is, the relationship and shape of structure 530 and airfoil blades 510 promote the directing and/or concentrating of fluid flow toward airfoil blades 510 to provide an enhanced energy-capturing capacity. As shown in FIGS. 27 and 28, in this aspect, the plurality of airfoil blades 510 of assembly 500 may comprise a plurality of sets 515 of airfoil blades 510. Each set 515 of blades 510 may comprise one or more, or a plurality of, individual blades 510. In the aspect shown in FIGS. 27 and 28, each set 515 comprises three individual blades 510, though aspects of the invention may have 2 or more, or four or more individual blades 510 per set 515.

Similar to blades 210 shown in FIGS. 18 through 20, blades 310 shown in FIGS. 21 through 23, and blades 410 shown in FIGS. 24 through 26, blades 510 may typically be “helical” in shape, twisting through an angle θ. In the aspect shown in FIGS. 27 and 28, the angle θ may range from about 15 degrees to about 360 degrees or more (depending upon the dimensions of assembly 400 and the available fluid flow), but angle θ for assembly 500 may typically be between about 90 degrees and about 450 degrees, for example, between about 150 degrees to about 390 degrees, for instance, about 360 degrees as shown in FIGS. 27 and 28. Though in one aspect, angle θ may be substantially constant for each set 515 of blades 510, as shown in FIGS. 27 and 28, the angle θ may also vary, for example, two or more sets 515 of blades 510 may twist through a different angle θ. The blades 510 may be evenly distributed about structure 530, for example, as shown in FIGS. 27 and 28, three sets 515 of blades 510 are evenly distributed, at about an angle of 120 degrees, about structure 530. In one aspect, sets 515 of blades 510 may not be evenly distributed about structure 530.

The surface 540 may typically be smooth and continuous, for example, to enhance the desired channeling and/or directing of wind flow. However, surface 540 may be interrupted or discontinuous due to the presence of windows and/or other structural features which may have minimal or no impact upon the gross function of directing fluid flow. Though surface 540 may typically be smooth and continuous, surface 540 may be comprised of individual segments or portions of structure 530 that may be provided to facilitate manufacture and/or construction of structure 530.

Structure 530 may typically comprise a base 560 and a top 570 opposite the base 560. Base 560 may typically be adapted to support assembly 500, for example, designed to mount structure 530 to a surface, for example, to ground, to a roof top, and/or to a support structure (not shown). As shown in FIGS. 27 and 28, base 560 may include one or more access openings, portals, window, or doors 575, for example, to provide access and entry for personnel, for example, technicians attending to assembly 500, residents residing in assembly 500, or workers occupying assembly 500, among others. Access openings, portals, or doors 575 may also be provided to permit access to wiring and plumbing, for example, for power transmission lines adapted to transmit the electric power generated by assembly 500.

Top 570, as shown in FIGS. 27 and 28, may comprise a housing 575, for instance, a generally cylindrical housing containing one or more structures adapted to operatively mount airfoil blades 510 to assembly 500 and, possibly, house or support an electrical generator 550, among other equipment.

According to one aspect, the plurality of airfoil blades 510 include at least one end adapted to be mounted to or about top 570 of structure 530. For example, as shown in FIGS. 27 and 28, top 570 may include a rotor 580 mounted for rotation about axis 520 and adapted to engage airfoil blades 510. Rotor 580 may typically be operatively connected, for example, directly coupled, to, electrical generator 550. Though rotor 580 is shown positioned at or toward the top 570 of structure 530, rotor 580 may be positioned and adapted to be rotated at any axial position along structure 530, for example, adjacent to or in base 560, or anywhere between base 560 and top 570. In one aspect, two or more rotors 580 may be mounted for rotation along structure 530 and be operatively connected to one or more electrical generators 550.

Though rotor 580 may comprise any shape adapted to rotatably mount to structure 530 and engage blades 510, in the aspect shown in FIGS. 27 and 28, rotor 580 may comprise a substantially flat, circular plate 582. Plate 582 is adapted to engage and support blades 510, for example, by conventional means, for instance, by mechanical fasteners (not shown) and/or welding.

Though in one aspect, airfoil blades 510 may be substantially mounted to and supported by only one rotor 580, typically, blades 510 may also be mounted to and supported by one or more support rings 590. In the aspect shown in FIGS. 27 and 28, assembly 500 includes two support rings 590, though one or more evenly spaced rings 590 may be provided along structure 530. Support rings 590 may comprise a substantially flat plate 592 and may include lobes (not shown), for example, evenly distributed lobes, which are adapted to engage and support blades 510, for example, by conventional means. Though in one aspect, rings 590 may be operatively connected to an electrical generator, in the aspect shown, rings 590 are adapted to rotate about structure 530 as impelled by airfoil blades 510. Accordingly, in one aspect, rings 590 may be mounted for rotation by means of friction reducing devices (not shown), for example, roller bearings, journal bearings, friction reducing materials (such as, DuPont's Teflon® polytetrafluoroethylene (PTFE) or Saint-Gobain's Rulon® PTFE or their equivalents), and/or a lubricated surface.

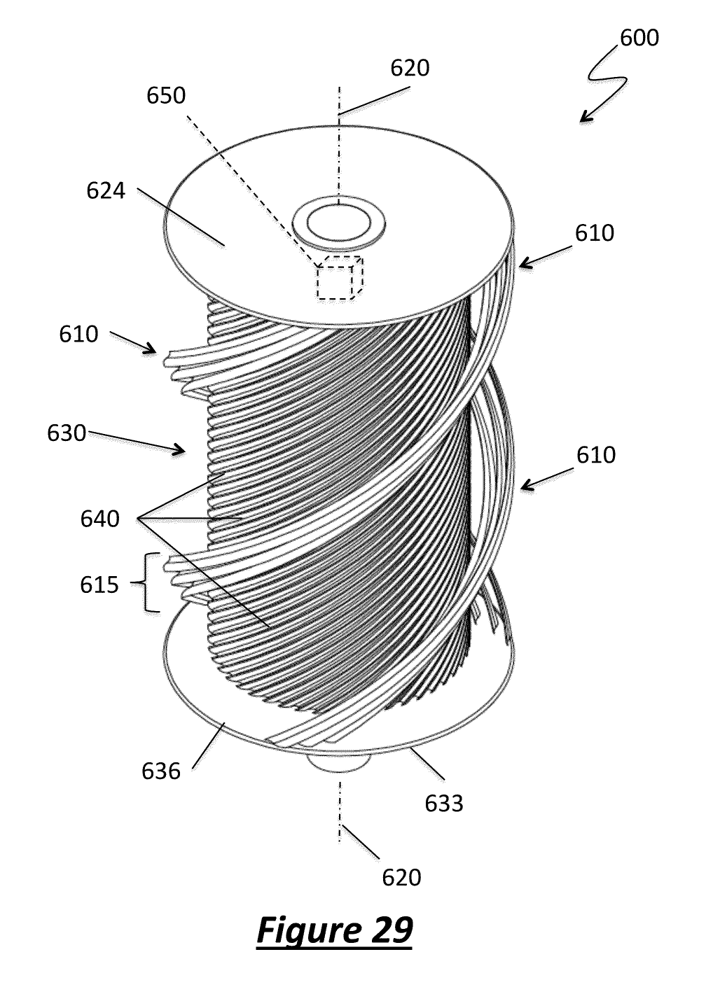

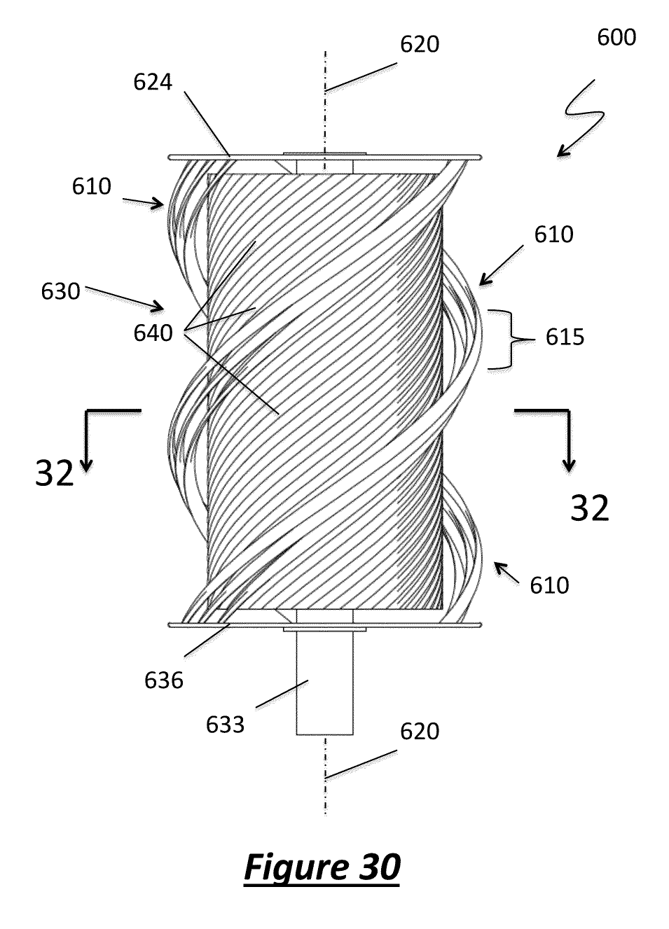

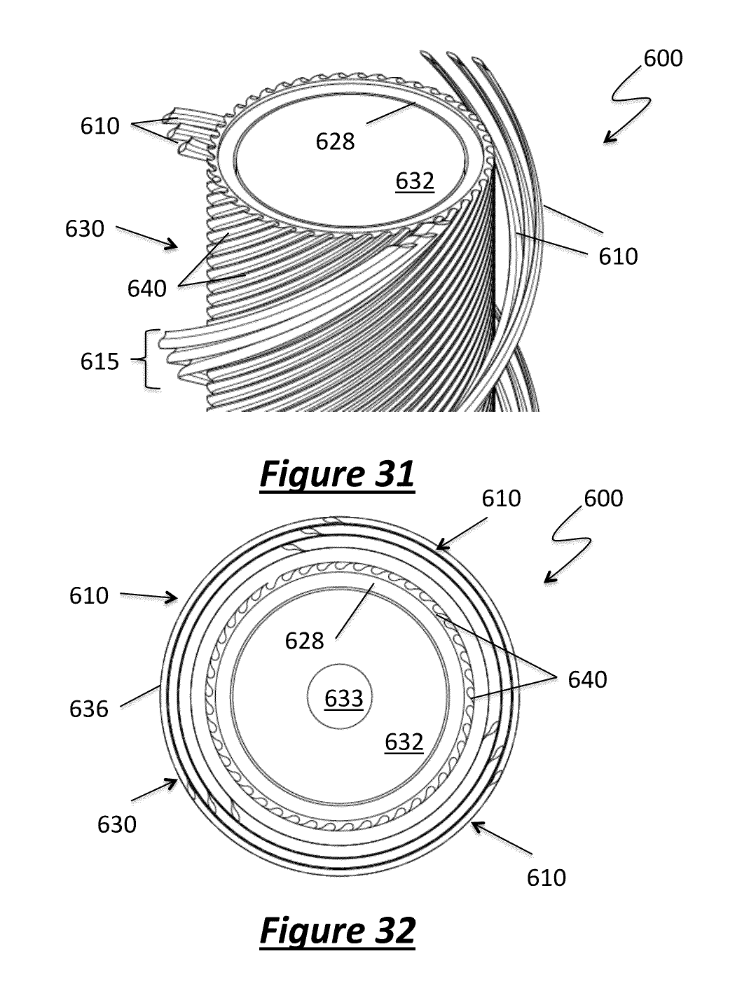

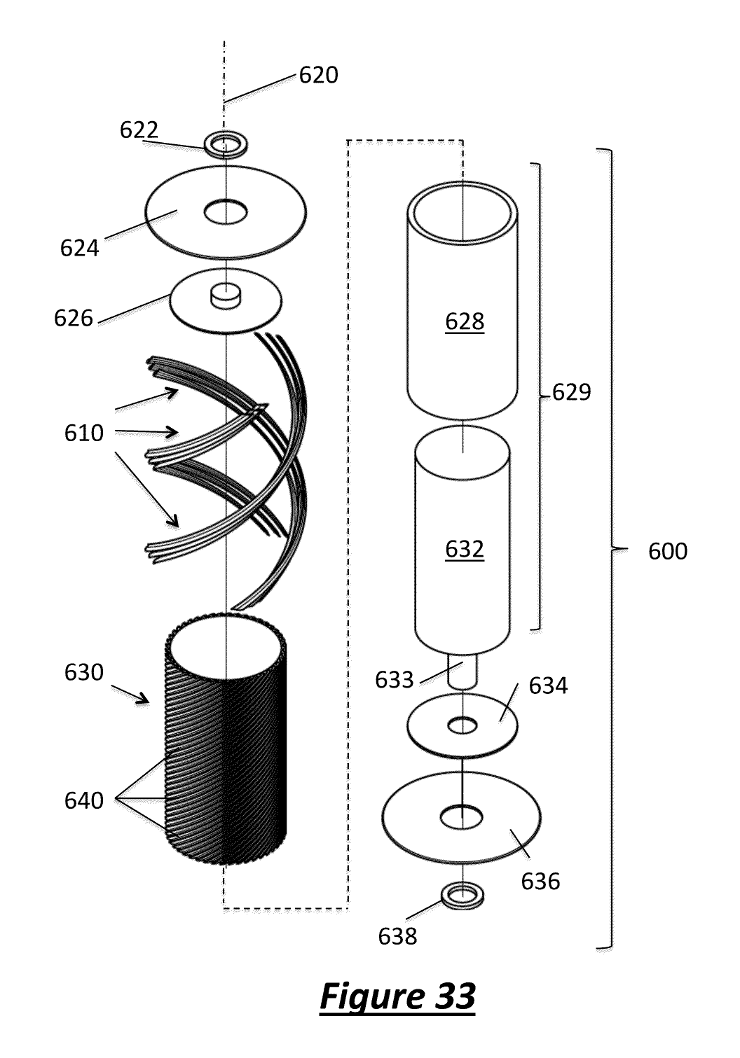

FIG. 29 is a perspective view of a wind turbine or wind turbine assembly 600 according to a further embodiment of the invention. Wind turbine 600 may be similar in size, function, and features, to wind turbines 10, 30, 40, 50, 60, 70, 80, and 90 described above. FIG. 30 is a side elevation view of the wind turbine or wind turbine assembly 600 shown in FIG. 29. FIG. 31 is a perspective view, partially in cross section, of the wind turbine or wind turbine assembly 600 shown in FIG. 29, and FIG. 32 is a cross section view of the wind turbine or wind turbine assembly 600 shown in FIG. 29 as viewed along section lines 32-32 shown in FIG. 30. FIG. 33 is an exploded perspective view of the wind turbine or wind turbine assembly 600 shown in FIG. 29.

As shown, wind turbine 600 includes a plurality of helical airfoil blades 612 mounted for rotation about an axis 620, and a circular cylinder 630 (or inner circular cylinder 630) rotationally mounted along the axis 620 and having an outer surface comprising a plurality of helical grooves 640. In one aspect, the rotationally mounted cylinder 630 is coupled to an electrical generator 650, for example, positioned within wind turbine 600, to generate electrical energy from the energy of a flowing fluid. According to aspects of the invention, when exposed to a flow of fluid, for example, air or water, the grooves 640 of cylinder 630 promote the rotation of cylinder 640 and the generation of electrical energy by generator 650.

As shown most clearly in the exploded view of FIG. 33, wind turbine 600 may also include a first or top bearing 622 adapted to rotationally support rotating cylinder 630, a top mounting plate 624 adapted to engage the helical blades 610, a top plate 626 adapted to mount to and retain a generator stator 632 of generator 629, a generator rotor 628 of generator 629 to which cylinder 630 may be mounted, a generator stator 632 adapted to engage generator rotor 628 (the stator 632 having a shaft or journal 633), a bottom plate 634 adapted to mount to and retain generator stator 632, bottom mounting plate 636 adapted to engage the helical blades 610, and a bottom bearing 638 adapted to rotationally support rotating cylinder 630.

In one aspect of the invention, the helical airfoil blades 612 may rotate “freely,” for example, the rotation of airfoil blades 612 may not be restricted by any means, or may not be coupled to any form of electrical generator. However, in another aspect, airfoil blades 612 may be coupled to an electrical generator, for example, generator 650. According to aspects of the invention, the rotation of helical airfoil blades 612 may be at least partially promoted by the circular cylinder 630, for example, by the helical grooves 640 of cylinder 630. In one aspect, the speed of rotation of the circular cylinder 630 may be less than the speed of rotation of the helical airfoil blades 612. According to one aspect, the helical groove 640 of cylinder 630 when exposed to a flow of fluid, such as wind, capture at least some of the wind energy and induces the rotation of cylinder 630. The turning force captured by cylinder 630 is converted to electrical energy by generator 650. In one aspect, the helical airfoil blades (or outer airfoil blades) 610 may generate localized reductions in pressure, or a “draft,” while rotating about cylinder 630 (for example, when freely rotating) that promotes the rotation of cylinder 630.

As shown most clearly in FIGS. 31 and 32, helical grooves 640 in cylinder 630 may comprise a plurality of recesses or depressions in the surface of cylinder 630. The recesses or depressions may be radiused or non-radiused. For example, the recesses that comprise grooves 640 may have bottom surfaces that comprise smooth curves, for example, radiused curves, or the recesses that comprise grooves 640 may have bottom surfaces that may comprise substantially planar surfaces. In one aspect, the cross sectional shape of grooves 640 may be teardrop shaped.

As also shown in FIGS. 31 and 32, airfoil blades 310 may comprise teardrop-shaped cross sections, for example, as is typical of airfoils in the art. In addition, according to one aspect of the present invention, any and all of the airfoil blades disclosed herein may have a similar teardrop-shaped cross section. According to aspects of the invention, airfoil blades 310 (and any and all airfoil blades disclosed herein) may have a sharp edge adapted to effectively effortlessly cut into a fluid, such as air, and separate the fluid flow. It one aspect, the airfoil blade according to aspects of the invention starts off with a wider tangent wavelength curve along the top. A narrower tangent curve at the bottom of the airfoil may be “wavy” in its design, for example, so whenever drag starts building up around a curve, and turning the curve in the other direction, it eliminates the drag and directs and accelerates the fluid flow.

In another aspect, the speed of rotation of cylinder 630 may be coupled or related to the speed of rotation of the helical airfoil blades 610. For example, cylinder 630 may be mechanically coupled to airfoil blades 610 whereby they rotate in unison. In another aspect, the speed of rotation of cylinder 630 may be a function of the speed of rotation of the helical airfoil blades 610, for example they may be coupled by common drive belts, drive chains, or gears.

In one aspect, as shown most clearly in FIGS. 32 and 33, the inner cylinder 630 may be coupled to the rotor 628 of a generator 629. For example, cylinder 630 may be rigidly mounted to rotor 628, or cylinder 630 may comprise the outer rotor of generator 629 positioned within cylinder 630 whereby both cylinder 630 and rotor 628 rotate in unison or in sequence. As shown, in FIG. 33, the stator 632 of generator 629 may comprise a fixed shaft or journal 633 to retain stator 632.

Similar to wind turbines 10, 30, 40, 50, 60, 70, 80, and 90, cylinder 630 having helical grooves 640 of wind turbine 600 may be shaped to direct a flow of fluid, for example, water or air, toward the plurality of helical airfoil blades 610. Though shown directed substantially vertically, axis 620 may be directed in any appropriate orientation based upon the desired installation, for example, substantially horizontally or substantially vertically, among other orientations.

Wind turbine 600 may typically include at least one electrical generator 650, for example, mounted within cylinder 630, operatively connected to the cylinder 630, the plurality of rotating airfoil blades 610, and/or both. Again, the shape and size of airfoil blades 610 and cylinder 630 reflect the shape, relationship, and function of the airfoil blades and cylindrical airfoils disclosed throughout this specification. That is, the relationship and shape of cylinder 630 and airfoil blades 610 may promote the directing and/or concentrating of fluid flow toward airfoil blades 610 to provide an enhanced energy-capturing capacity. As shown in FIGS. 29 through 33, in this aspect, the plurality of airfoil blades 610 may comprise a plurality of sets 615 of airfoil blades 610. Each set 615 of blades 610 may comprise one or more, or a plurality of, individual blades 610. In the aspect shown in FIGS. 29 through 33, each set 615 comprises three individual blades 610, though aspects of the invention may have 2 or more, or four or more individual blades 610 per set 615.

Similar to airfoil blades disclosed earlier, airfoil blades 610 may typically be “helical” in shape, twisting through an angle θ. In the aspect shown in FIGS. 29 through 33, the angle θ may range from about 15 degrees to about 360 degrees or more (depending upon the dimensions of wind turbine 600 and the available fluid flow), but angle θ for wind turbine 600 may typically be between about 90 degrees and about 360 degrees, for example, between about 150 degrees to about 270 degrees, for instance, about 180 degrees as shown in FIGS. 29 through 33. Though in one aspect, angle θ may be substantially constant for each set 615 of blades 610, as shown in FIGS. 29 through 33, the angle θ may also vary, for example, two or more sets 615 of blades 610 may twist through a different angle θ. The blades 610 may be evenly distributed about cylinder 630, for example, as shown in FIGS. 29 through 33, three sets 615 of blades 610 are evenly distributed, at about an angle of 120 degrees, about cylinder 630. In one aspect, sets 615 of blades 610 may not be evenly distributed about cylinder 630.

In one aspect, the helical direction of the plurality of airfoil blades 610 may be substantially the same direction as the helical direction of the plurality of the helical grooves 640, though the helical directions may be opposite.

As disclosed above and claimed below, aspects of the present invention provide wind turbines and energy capturing assemblies with an enhanced ability to capture fluid energy, for example, water wave energy or wind energy. Aspects of the invention increase the fluid loading on airfoil blades by coupling the airfoil blades with inner structures which channel fluid flow toward the airfoil blades to increase the loading and energy captured by the airfoils. Some embodiments of the invention include wind turbines that can be mounted in clusters of turbines. The energy capturing capacity of these turbines can be further enhanced by incorporating photovoltaic devices. Other embodiments include structures, for example, large structures, such as, buildings, that can be used to capture wind energy.

While several embodiments and aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

1. A wind turbine comprising:
a plurality of helical air foil blades mounted for rotation about an axis; and
a cylindrical airfoil mounted along the axis and shaped to direct a flow of air toward the plurality of helical airfoil blades.

2. The wind turbine as recited in claim 1, wherein at least one of the plurality of helical air foil blades and the cylindrical airfoil is adapted to drive an electrical generator.

3. The wind turbine as recited in claim 1, wherein the plurality of helical airfoil blades comprises three spaced helical blades.

4. The wind turbine as recited in claim 1, wherein the axis is oriented one of horizontally and vertically.

5. The wind turbine as recited in claim 1, wherein the cylindrical airfoil includes a plurality of photovoltaic devices.

6. The wind turbine as recited in claim 5, wherein the cylindrical airfoil further includes a plurality of reflective surfaces adapted to reflect sunlight onto the plurality of photovoltaic devices.

7. The wind turbine as recited in claim 1, wherein the wind turbine further comprises a means for directing wind to provide the flow of air.

8. The wind turbine as recited in claim 7, wherein the means for directing the wind comprises a surface positioned to capture and direct the wind toward the cylindrical airfoil.

9. The wind turbine as recited in claim 8, wherein the surface comprises a surface of a structure.

10. The wind turbine as recited in claim 9, wherein the surface of a structure comprises a roof.

11. A method for capturing wind energy comprising:
mounting a plurality of helical airfoil blades for rotation about an axis;
positioning a cylindrical airfoil along the axis; and
allowing a surface of the cylindrical airfoil to direct a flow of air toward the plurality of helical airfoil blades to at least partially assist in rotating the plurality of helical airfoil blades.

12. The method as recited in claim 11, wherein the method further comprises driving an electric generator by a means of one of the plurality of helical airfoil blades to generate electric power.

13. The method as recited in claim 11, wherein positioning the cylindrical airfoil along the axis comprises rotatably mounting the cylindrical airfoil along the axis.

14. The method as recited in claim 13, wherein the method further comprises driving an electric generator by a means of the rotatably mounted cylindrical airfoil to generate electric power.

15. The method as recited in claim 11, wherein the axis comprises one of a horizontal axis and a vertical axis.

16. The method as recited in claim 11, wherein the method further comprises capturing solar energy with a plurality of photovoltaic devices positioned on the cylindrical airfoil.

17. The method as recited in claim 16, wherein the method further comprises reflecting sunlight onto the plurality of photovoltaic devices.

18. The method as recited in claim 11, wherein the method further comprises directing wind toward the cylindrical airfoil.

19. The method as recited in claim 18, wherein directing the wind comprises positioning a surface adapted to capture and direct the wind toward the cylindrical airfoil.

20. The method as recited in claim 19, wherein positioning the surface to capture and direct the wind toward the cylindrical airfoil comprises mounting the cylindrical airfoil adjacent a roof of a structure, wherein the roof comprises the surface adapted to capture an direct the wind.

21-58. (canceled)
